(19) United States
(12) Patent Application Publication
(10) Pub. No.: US 2025/0322327 A1
(43) Pub. Date: Oct. 16, 2025

(54) UNIVERSAL TIME-SERIES FORECASTING WITH ADAPTIVE INPUTS/OUTPUTS FOR REAL-WORLD RANDOM MISSING DATA

(71) Applicant: VOLKSWAGEN AKTIENGESELLSCHAFT, Wolfsburg (DE)

(72) Inventors: Saeth Wannasuphoprasit, San Francisco, CA (US); Gianina Alina Negoita, San Leandro, CA (US)

(21) Appl. No.: 18/635,555

(22) Filed: Apr. 15, 2024

(51) Int. Cl. G06Q 10/0631; G06N 7/01

(52) U.S. Cl. CPC G06Q 10/06311; G06N 7/01

(57) ABSTRACT

According to one embodiment, first input features are extracted from received past time-dependent inputs. The first input features are represented at least in part by a first plurality of input time series. A first encoder output array is generated by a first encoder with a first cross-attention mechanism based at least in part on the first input features. The first encoder output array is provided as query, key and value inputs to a pretrained core model with a self-attention mechanism to generate a core model output array. Forecasting results in a forecasting time period are generated by a decoder based at least in part on the core model output array. The forecasting results are represented by one or more output time series.

### TECHNICAL FIELD

Embodiments relate generally to artificial intelligence, and, more specifically, to generalizable and flexible probabilistic multi-variable time-series forecasting for real-world random missing data.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Artificial intelligence (AI) and machine learning (ML) systems are being developed and applied to solve more and more problems in a wide variety of application scenarios. Numerous data sources for machine or human generated data may be used to generate input and output training data to train machine learning systems in a training phase and to generate input non-training data for the trained systems to generate forecasts in an inference phase.

For example, input training data may be received and processed by an AI/ML system to generate forecasts in the training phase. These forecasts may be compared with ground truths or labels in output training data to generate prediction errors between the forecasts and ground truths. The errors can be back propagated within the machine learning systems to optimize different layers, neural networks, transformers, encoders, processors, decoders, (e.g., multi-layer, etc.) perceptrons, or other machine learning modules in the system.

Typically, the quality of the forecasts by the machine learning systems may be largely dependent on the quality of the training data or non-training data. Missing data or temporal variations and gaps in the training data or non-training data may directly impact on the quality and accuracy of forecasts generated by AI/ML systems.

### BRIEF DESCRIPTION OF DRAWINGS

The present invention is illustrated by way of example, and not by way of limitation, in the figures of the accompanying drawings and in which like reference numerals refer to similar elements and in which:

FIG. 1A illustrates example time series analysis/forecasting operations; FIG. 1B and FIG. 1C illustrate example variable selection and attention plots; FIG. 1D illustrates example time-dependent inputs;

FIG. 2A illustrates an example AI/ML forecasting system or framework; FIG. 2B illustrates an example variable selection mechanism; FIG. 2C illustrates example latent array generation; FIG. 2D illustrates example K and V input or matrix generation; FIG. 2E illustrates example cross-attention encoder operations; FIG. 2F illustrates example multi-head cross attention encoder operations; FIG. 2G illustrates example core model operations; FIG. 2H illustrates example single head cross attention decoder operations; FIG. 2I illustrates example multi-head cross attention decoder operations;

FIG. 3A and FIG. 3B illustrate example smart home energy management systems or frameworks;

FIG. 4 illustrates an example process flow; and

FIG. 5 is a block diagram of an example computer system upon which embodiments of the invention may be implemented.

### DETAILED DESCRIPTION OF THE INVENTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0. General Overview
2.0. Structural Overview
   2.1. Time Series Forecasting
   2.2. Gaps and Variations
   2.3. Forecasting System
   2.4. Positional Encoding
   2.5. Encoders, Decoders and Core Model
   2.6. K, V and Q Matrices
   2.7. Element-Wise Multiplication
   2.8. Variable Selection Mechanism
   2.9. Feedforward Matrix Multiplication
3.0. Functional Overview
   3.1. Latent Array Generation
   3.2. K and V Input Generation
   3.3. Core Model Operations
   3.4. Encoder Operations
   3.5. Decoder Operations
   3.6. Use Cases
   3.7. Optimizing EV Charging
   3.8. Forcasting SOC and Home Availability
   3.9. Forcasting Home Energy Demand/Generation
4.0. Example Process Flows
5.0. Implementation Mechanism—Hardware Overview
6.0. Extensions and Alternatives

### 1.0. General Overview

In an AI/ML system as described herein, past inputs, both time-dependent and time-independent, may be merged together with a first cross-attention mechanism. In addition, future inputs can be merged together with a second cross-attention mechanism. These mechanisms can be implemented to provide a capability of handling relatively (e.g., much greater than 512 elements, etc.) long input sequence by mapping relatively long time-dependent inputs into a relatively short sequence. By way of example but not limitation, an input sequence of a relatively long length of 576 inputs or elements can be mapped into a relatively short sequence or latent array of a length of 60 inputs or elements. As used herein, a latent array may refer to an array of data elements, feature vectors or feature matrices that is generated by or outputted from artificial neural networks (e.g., feed forward networks, transformers, multi-layer perceptrons, attention transformers, etc.) or layers/subnetworks therein.

Input sequences or signals of past time-dependent inputs or elements can have (interleaving or interstitial) missing data, which may be relatively common in real-world data. The system or an ML or artificial intelligence (AI) model implemented therein can handle or process the input sequences or signals with missing data relatively robustly, using relative positional encoding encoded in, applied or adapted to the past time-dependent inputs or elements in the input sequences or signals. In some operational scenarios, relatively simple but effective positional encoding may be implemented with or adapted to a Perceiver IO architecture to handle missing time-series data in the (original) past time-dependent inputs. Example architectures and operations relating to Perceiver IO are described in “PERCEIVER IO: A GENERAL ARCHITECTURE FOR STRUCTURED INPUTS & OUTPUTS,” by Andrew Jaegle et al. 2022 (available at: https://arxiv.org/abs/2107.14795; accessed on Apr. 2, 2024), the contents of which are incorporated by reference in their entirety herein.

The past inputs or elements can be passed directly or indirectly (with shorter sequences or latent arrays) to a core model in the system for the model to learn generalized patterns from the past inputs or elements (or past data). The output generated by the second cross-attention mechanism from the future inputs can be used as a prompt for forecast (feature) generation.

The system includes a decoder, implemented as a third cross-attention mechanism, which takes as input both the output from the core model (from the past inputs) and the prompt or output generated by the second cross-attention mechanism from the future inputs to generate forecasts or target forecast features.

The system is uniquely or specifically implemented to support universal time-series forecasting tasks with wide varieties of different input data types, data sampling rates, or data compositions. The system can robustly handle, process or generate sequences or arrays of data elements of relatively long lengths (e.g., in input data, in output data, etc.) with the same or different sampling rates with or without missing data.

Relatively simple but effective variable selection mechanisms may be implemented in the system with a single matrix multiplication operation to help provide or enhance interpretation ability of deep learning models implemented in the system or mechanisms therein.

The system includes a relatively efficient time-series prompt mechanism for flexible time-series forecasting with the same or different sampling rates. The time-series prompt mechanism can be used to map a specific sampling rate in the past time-independent inputs along with future known inputs (both time-dependent and time-independent) into learnable prompts—for example, one from past inputs with the first cross-attention mechanism and another one from future inputs of the second cross-attention mechanism. The system can be implemented or adapted to handle relatively long inputs and outputs flexibly, to expedite the training phase of the system, and reduce inferencing times as compared with other approaches (e.g., Recurrent Neural Networks or RNNs, etc.).

Once the deep learning models in the system or mechanisms therein are trained or pre-trained (including but not limited to transfer learning), these models can be further fine-tuned in the subsequent model training and application phases—for example by freezing some or all (trained or pretrained) operational parameters such as weights and/or biases of the trained or pre-trained models optimized in the model training phase—with additional sampling rate(s) of the same or different training and/or non-training dataset(s) using transfer learning. The system and models therein can be relatively efficiently generalized, even in the model application or inference phase, to support different time-series sampling rates, different variables, or different past or future time-dependent or time-independent inputs.

Example approaches, techniques, and mechanisms are disclosed for time-series forecasting. According to one embodiment, first input features are extracted from received past time-dependent inputs. The first input features are represented at least in part by a first plurality of input time series. A first encoder output array is generated by a first encoder with a first cross-attention mechanism based at least in part on the first input features. The first encoder output array is provided as query, key and value inputs to a pretrained core model with a self-attention mechanism to generate a core model output array. Forecasting results in a forecasting time period are generated by a decoder based at least in part on the core model output array. The forecasting results are represented by one or more output time series.

In other aspects, the invention encompasses computer apparatuses and computer-readable media configured to carry out the foregoing techniques.

### 2.0. Structural Overview

A time series forecasting system or framework as described herein can be implemented or used to process time series input data representing past and future known time-dependent inputs as well as other input data representing past and future known time-independent inputs and generate or predict forecasting results in a forecasting period or duration. The time-dependent inputs such as the past time-dependent inputs can be transformed into respective time series comprising data points or tokens with positional encoding data such as relative timestamps. The encoding of the relative timestamps in the time series allows the time series forecasting system or framework to be trained or applied in a robust manner, even if the time-dependent inputs in the training or application phases may include missing data or time gaps within an overall time durations or intervals covered by the time series.

The time series forecasting system or framework can be trained or applied to a wide variety of application scenarios. For example, the system or framework as described herein may be used to process past and future known inputs relating to electric vehicles (EVs) and generate or predict forecasting results relating to future State of Charge (SoC) states/values, future home availability for a specific EV to be present at or absent from a specific home and to be available or unavailable for home-based electric charging operations at the specific home. Additionally, optionally or alternatively, the time series forecasting system or framework can be trained or applied to process past and future known inputs relating to homes with or without EVs and generate or predict forecasting results relating to future home based electricity demand/generation. In some operational scenarios, these forecasting results along with uncertainty assessments estimated for the forecasting results may be used by other systems implementing optimizing algorithms or methods for generating optimized EV charging or discharging schedules to help ensure the EVs and/or homes operating with the lowest costs or negative impacts in connection with EV and home based electricity demands/generation.

### 2.1. Time Series Forecasting

Time series analysis involves solving or performing various classification and regression problems or tasks to understand or learn hidden patterns in historical data. The time series analysis can gain or provide insights into past trends represented or embedded in the historical data, understand seasonality such as temporal or seasonal changes and/or patterns in the historical data or past trends, and make or generate relatively accurate or informed forecasts to answer questions about or generate predictions relating to the future. Time series forecasting may be included in the time series analysis to predict future logged and/or un-logged signal(s) over a future time period or duration using input feature(s) generated, extracted or learned from a list of selected or specific past and/or future signal/signals.

By way of example but not limitation, raw sensor data collected with a battery pack as described herein may be represented as one or more time series. A time series refers to a series or sequence of (e.g., consecutive, etc.) data points (of time-dependent variables) indexed or listed in time order. For example, electric voltage measurements (in the collected raw sensor data) made by a physical (or specifically voltage) sensor deployed with a cell or a module in the battery pack or the battery pack itself can generate a time series of voltage measurements at a corresponding cell, module or pack level. Electric current measurements (in the collected raw sensor data) made by a physical (or specifically current) sensor deployed with a cell or a module in the battery pack or the battery pack itself can generate a time series of current measurements at a corresponding cell, module or pack level. Temperature measurements (in the collected raw sensor data) made by a physical (or specifically temperature) sensor deployed with a cell or a module in the battery pack or the battery pack itself can generate a time series of temperature measurements at a corresponding cell, module or pack level. Additionally, optionally or alternatively, other time series such as time series of internal resistance, electric charge, electric charge capacity, pressure, etc., can be generated from measurements of respective physical sensors. Additionally, optionally or alternatively, some time series can be derived, for example based on physics laws and/or mathematical models, from some other time series generated from measurements of physical sensors.

Techniques as described herein can be implemented or applied to solves general time-series forecasting problems which works relatively well for many challenging and messy real-world datasets with some random missing signals or data portions, different prompts, different sampling rates, and variations in input and output lengths, etc. Under these techniques, real-world input data can be efficiently used for training and interference/forecasting operations, without needing to perform additional specific interpolation operations on the real-world data to handle missing data, data variations and sampling rate variations that may exist in the real-world input data.

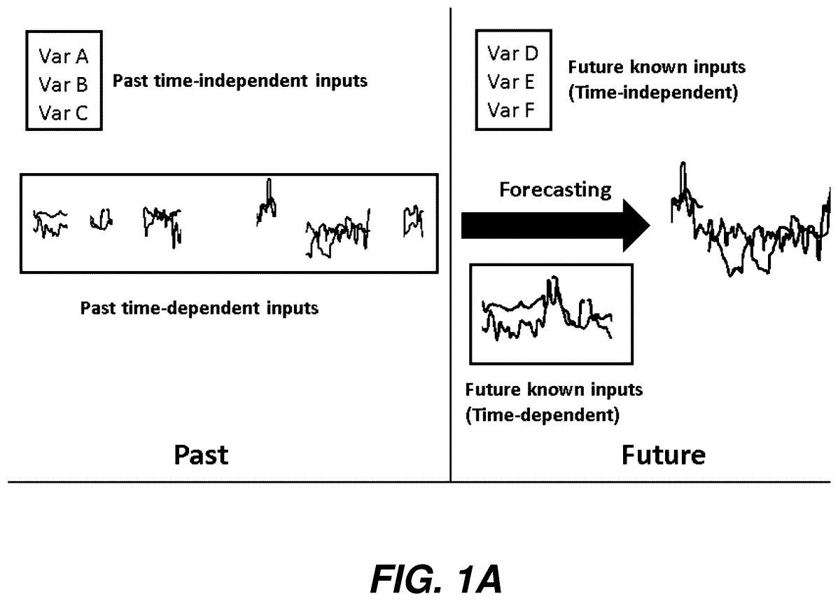

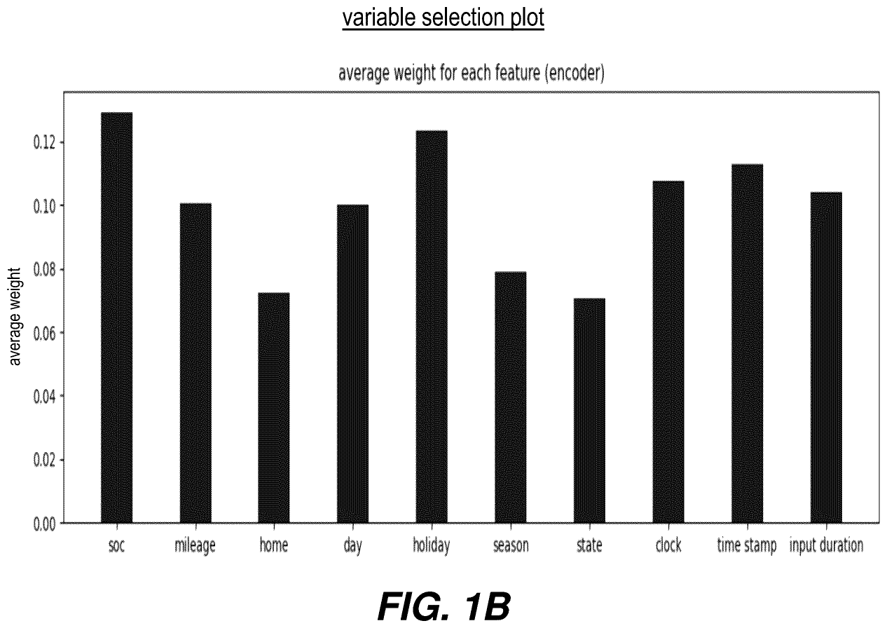

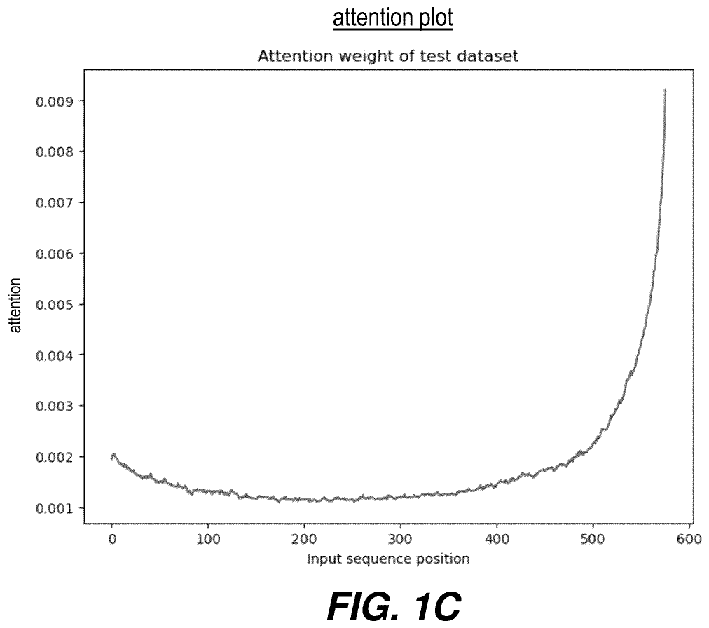

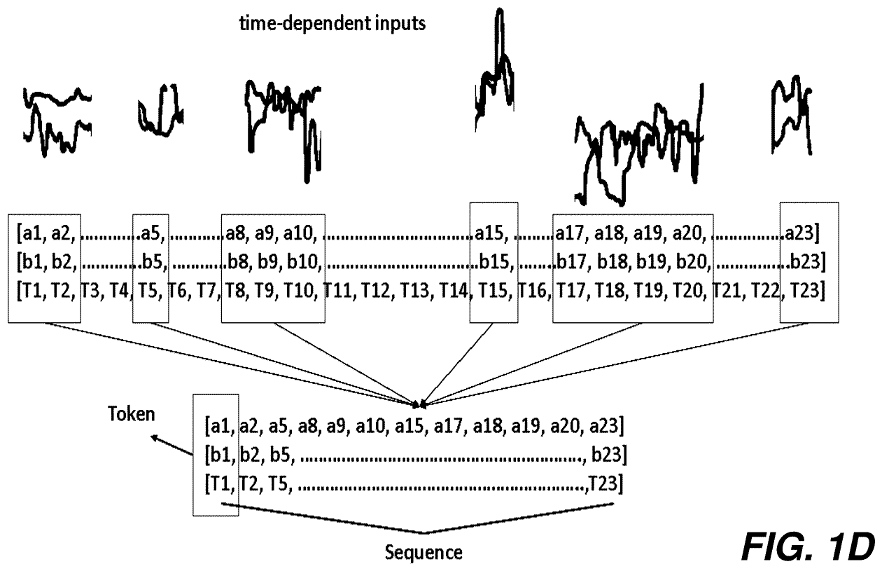

FIG. 1A illustrates example time series analysis/forecasting operations. Past inputs for the time series analysis or forecasting operations may include past time-dependent or time-variant inputs—or (past input) time series—in one or more past input datasets. The past input datasets or the (past input) time series therein may collectively cover a past time period or duration starting from a first time point in a timeline and ending at a second (subsequent) time point in the timeline. The past time-dependent inputs include—or may be derived with positional encoding from—some or all (e.g., relevant, etc.) input features that have the potential to be inputs or arguments of forecasting variables/features. These input features may be represented by data points each of which may be tagged or indexed with a corresponding (e.g., relative, etc.) timestamp or a temporal position. In some operational scenarios, the timestamps or temporal positions may be indicated with a value in a normalized value range such as between 0 and 1, where zero (0) represents a timestamp of the very first data point of the input features and one (1) represents a timestamp of the last data point of the input features.

The past inputs for the time series analysis or forecasting operations may further include past time-independent or time-invariant inputs within the past time period or duration covered by the past time-dependent or time-variant inputs. The past time-independent inputs include some or all (e.g., relevant, etc.) static/constant/fixed variables/inputs (not depending on or varying with time) such as a sampling rate used to generate the datasets of the past time-dependent inputs in a time duration covered by the datasets or past time-dependent inputs.

Future (known) inputs for the time series analysis or forecasting operations may include future time-dependent or time-variant inputs—or (future known input) time series—in one or more future (known) input datasets. The future input datasets or the (future known input) time series therein may collectively cover a future time period or duration starting from a third time point in the timeline and ending at a fourth (subsequent) time point in the timeline. The future known time-dependent inputs include some or all (e.g., relevant, etc.) inputs that depend on or vary with time and that are going to happen in a forecasting timeframe or duration such as a sequence of (next few) days (e.g., next Monday to Sunday, today, today and tomorrow, next 12, 24 or 48 hours, etc) corresponding to future time points for which forecasting features or variables are to be generated by a time series forecasting system as described herein.

The future (known) inputs for the time series analysis or forecasting operations may further include future time-independent or time-invariant inputs—or static/constant/fixed—within the future time period or duration covered by the future time-dependent or time-variant inputs. The future time-independent inputs include some or all (e.g., relevant, etc.) static/constant/fixed variables/inputs (not depending on or varying with time) such as a sampling rate and/or a forecasting timeframe or duration used to generate the forecasting features or variables.

The (past input) time series represented in the past input datasets or the past time-dependent inputs may correspond to the same or different sampling rates (e.g., every 1 ms, every 10 minutes, every day, etc.). Likewise, the (future input) time series represented in the future input datasets or the future time-dependent inputs may correspond to the same or different sampling rates (e.g., every 1 ms, every 10 minutes, every day, etc.). Some or all of these input datasets or time series may be represented in different input formats, input sampling rates, input lengths, input precisions, etc.

The past and future input datasets or time series along with time-invariant past and future inputs may be used by the system to make or generate target predictions such as one or more output datasets or output time series covering a future time period or duration—which may, but is not necessarily limited to only, be the same as the future time period or duration covered by the future datasets or inputs. Some or all of these output datasets or time series may be represented in different output formats, output sampling rates, output lengths, output precisions, etc. The output datasets or time series comprise the forecast or predicted features or variables that are generated by specific forecasting tasks based on the datasets for the past and future known (time dependent and time-independent) inputs.

### 2.2. Gaps and Variations

In some operational scenarios, as illustrated in FIG. 1A, the time-dependent or time-variant inputs in the (e.g., real-world, etc.) past input datasets—or the time series—may not have any past time-dependent or time-variant input data for one or more time intervals within the past time period or duration covered by the past input datasets. These time intervals represent time gaps with (e.g., random, etc.) missing data.

Indeed, real-world datasets usually have random missing data. In addition, the real-world datasets such as those collected from a wide variety of vehicles may be generated with different sampling rates (e.g., 1 ms, 10 minutes, 1 day, etc.), different lengths, different data types, different input format, different numerical or non-numerical representations, different precisions, different static (time-invariant) inputs in the past or past time-independent inputs, different future known inputs (time-dependent and time-independent), and different desired input and output (forecasting) lengths.

The presence of missing data may be problematic to other approaches such as statistical and deep learning approaches that do not implement techniques as described herein. Some of these approaches might handle missing data using interpolation but still are prone to generating relatively inaccurate estimations of missing data especially in scenarios in which time gaps of missing data are relatively large. In addition, missing data with relatively large time gaps could make data insufficient for training, validating, and testing learning models.

Techniques as described herein can be used to implement or build a (e.g., universal, etc.) multi-variable time-series forecasting framework to address problems in time-series forecasting that are difficult to address with other approaches. The forecasting framework includes a number of specific features relating to both forecasting inputs and forecasting outputs.

For example, the forecasting framework may be implemented with specific features for forecasting with missing data. These features allows or support (e.g., raw, real-world, etc.) time-series input data including but not limited to input data with random missing data (e.g., in past time-dependent inputs, etc.) to be used for performing classification and/or regression forecasting tasks relatively accurately. The time-series input data can be inputted into the forecasting framework and processed to generate classification and/or regression predictions without needing to handle or fill the missing data with interpolation. Instead, a relatively simple but effective positional encoding mechanism can be included in the forecasting framework as described herein to encode timing information or a respective (e.g., relative, in relation to a present time point, etc.) timestamp to each input token represented in the time series input data. The positional encoding as described herein—e.g., encoding the timing information or timestamp along with each input token, etc.—results in having some or all input data available to train, validate, and test without dropping or losing any data portion. Hence, the forecasting framework as described herein can perform its forecasting tasks relatively robust even where the quality of the input data might not be otherwise appropriate or usable in other approaches—e.g., there may be a relatively large number of missing data portions or time gaps in real-world datasets, etc.

The forecasting framework as described herein can perform forecasting tasks with relatively flexible prompts including but not limited to relatively flexible sampling rates. For example, the same dataset such as electric vehicle (EV) battery usage time series (input) data can have data portions generated with different sampling rates as well as other or additional variables other than the past time-dependent inputs represented in the time series.

Under other approaches, it would not be practical, suitable or robust to train separate learning models for each sampling rate (and/or each distinct combination of the other or additional variables other than the past time-dependent inputs) when training these learning models with the same dataset.

In comparison, in the forecasting framework as described herein, different sampling rates can be relatively easily or efficiently handled with a time-series prompt mechanism included in the forecasting framework. Sampling rate(s) can be provided to the forecasting framework as input(s) in the past time-independent inputs, as well as input(s) in future known (time-dependent and time-independent) inputs to generate learnable prompts to the deep learning models in the forecast framework to train a generalized model that works for many sampling rates (and many different combinations of the other or additional variables other than the past time-dependent inputs). These models in the forecasting framework can be utilized or trained with the same dataset but with different sampling rates (and different combinations of the other or additional variables other than the past time-dependent inputs) using transfer learning by freezing some parts of the pre-trained model parameters and hence eliminating the need to train from scratch (e.g., for each sampling rate, for each combination of the other or additional variables, etc.).

Unlike forecasting models under other approaches, the forecasting framework as described herein helps improve forecasting performance and enhance forecasting accuracy with a wide variety of different time-series input (e.g., data, etc.) formats in which data inputs to the deep learning models may be represented. These inputs to the model include past time-independent inputs, future known inputs (both time-dependent and time-independent), and past time-dependent inputs such as time series that are only observed in the past. Some or all (e.g., different, etc.) input formats can be processed respectively with corresponding (e.g., different, etc.) cross-attention mechanisms in the forecasting framework to learn complex patterns from these different inputs as much as possible.

Forecasting can be performed or made with relatively long and flexible inputs and outputs. Regardless of which specific datasets and/or use cases, the forecasting framework as described herein can be used to handle or process relatively long inputs—which would otherwise be difficult to handle by a transformer architecture such as BERT with a maximum of 512 input tokens—to capture long-term dependencies as well as to handle or support relatively flexible or varying input and output lengths. By way of example but not limitation, relatively accurate forecasting relating to a vehicle's location (classification) and state of capacity or SOC (regression) using EV battery usage time-series data with relatively long and varying input lengths (576 input tokens varying from less than 30 days to 180 days) and different output lengths (e.g., 1 day, 2 days, etc.). The same generalized deep learning models can be used to support these different and varying input data or lengths using a transfer learning method without needing to train from scratch every time when different input and/or output sizes or lengths are used by the models.

The forecasting framework can be used or implemented with a weighted loss mechanism to perform forecasting tasks relating to rare and uncommon events. The weighed loss mechanism can assign relatively high weights to (e.g., input, past, etc.) data relating to the rare and uncommon events such as transition points between locations as compared with other events such as non-transition points (e.g., staying at one location, during a trip, etc.), thereby reducing or preventing biases in favor of the non-transition points. The weighted loss mechanism reinforces the learning models to better capture uncommon patterns such as transition points from one location to another of a vehicle. While most of the time the vehicle is either at home or not at home, capturing or forecasting the exact time when vehicle leaves the home or comes back home is relatively challenging. The (e.g., sample, etc.) weighted loss mechanism can be used to capture this transition relatively accurately.

Many other learning approaches lack interpretation capability to explain how their models works. In comparison, some or all of the deep learning models in the forecasting framework as described herein can explain which inputs and/or variables among some or all time-series inputs (e.g., as illustrated in FIG. 1A, etc.) are more important as compared with other inputs and/or variables for generating or making relatively accurate forecasting. A relatively simple Softmax matrix multiplication variable selection mechanism may be implemented to capture and indicate relative importances of the inputs and/or variables. Some variables such as timestamps may have more impact on forecasting—the learning model may focus more or place more weights on those inputs and/or variables to make or generate target predictions. Model parameters in an attention mechanism as described herein—after processing the past and/or future (known) inputs and generating forecasting outputs—can indicate or explain which inputs and/or variables are important for forecasting and can also be plotted and visualized to indicate which input (e.g., temporal, etc.) positions of all time-dependent inputs have a relatively influence on making or generating the target predictions as compared with the other input (e.g., temporal, etc.) positions.

The learning models such as the attention mechanisms in the forecasting framework are implemented or configured to learn both short and long-term patterns in time-dependent input data. By way of example but not limitation, the time-dependent input data may be EV battery usage and home energy demand dataset, the attention mechanisms can learn input or temporal positions relating to individual tokens or data portions in the past time-dependent inputs or patterns in these input or temporal positions and/or the tokens and/or data portions and focuses on or pays attention to both the beginning (long-term in the past relative to a present time point) and the end (short-term in the past relative to the present time point) of these input or temporal positions as well as intermediate input or temporal positions.

In summary, techniques as described herein may be implemented to provide a (e.g., universal, etc.) forecasting framework for probabilistic multi-variable time series forecasting with relatively high performance and robustness for real-world random missing data with relatively flexible inputs, outputs, and input prompts including sampling rates. After deep learning models of the forecasting framework are trained or pre-trained, some or all model parameters such as weights and/or biases of the pre-trained model (e.g., the transformer encoder or core model, multiple attention heads with GELU( ) activation function, etc.) can be frozen or further fine-tuned with new or additional input variables or prompts or with new data configurations/combinations, thereby saving computation resources and times. A weighted loss mechanism may be implemented with the deep learning model to better capture rare events such as relating to vehicle coming home or leaving home. Additionally, optionally or alternatively, quantile loss for regression forecasting with uncertainty may be implemented. To help explain which specific variables and/or time points represented in some or all time-series related inputs have more influence on forecasting as compared with the other variables and/or other time points represented in the inputs, a relatively efficient variable selection mechanism utilizing matrix multiplication with the Softmax activation function may be implemented. Additionally, optionally or alternatively, to provide or support a capability of learning both short-term and long-term dependencies and/or patterns in the time-dependent time-series inputs, attention mechanisms can be implemented or utilize to visualize or indicate which specific input or temporal positions in the inputs have more impact on the time-series forecasting as compared with other input or temporal positions in the inputs.

### 2.3. Forecasting System

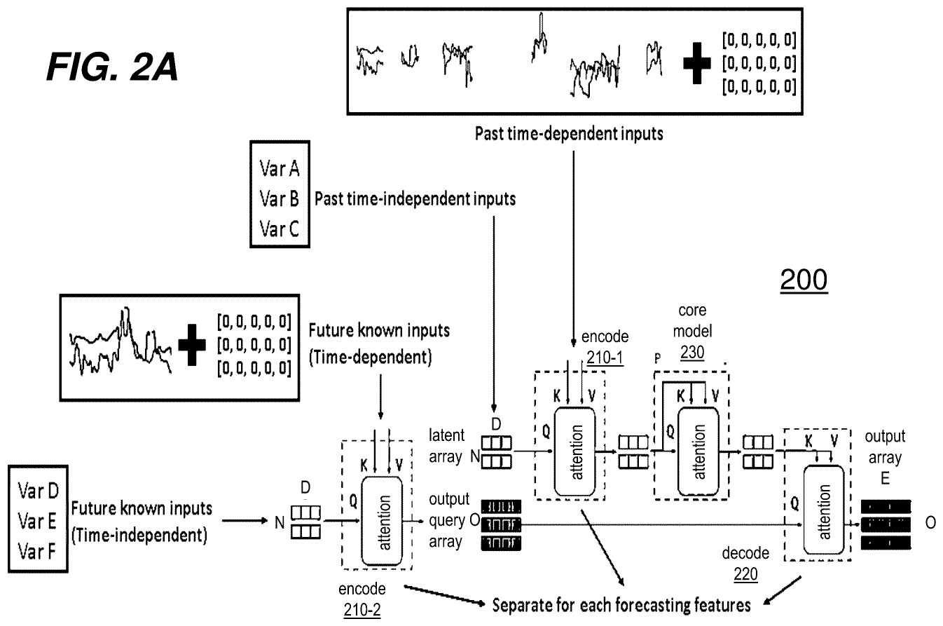

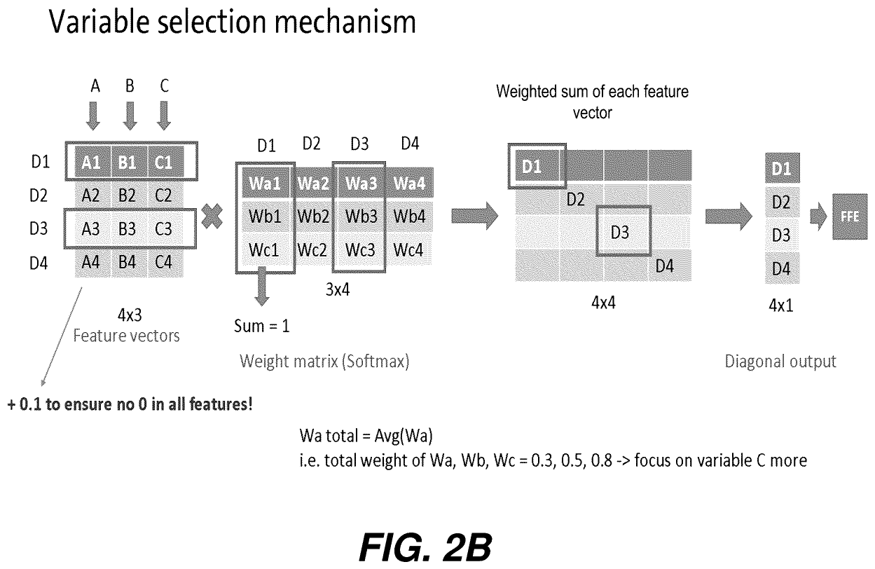

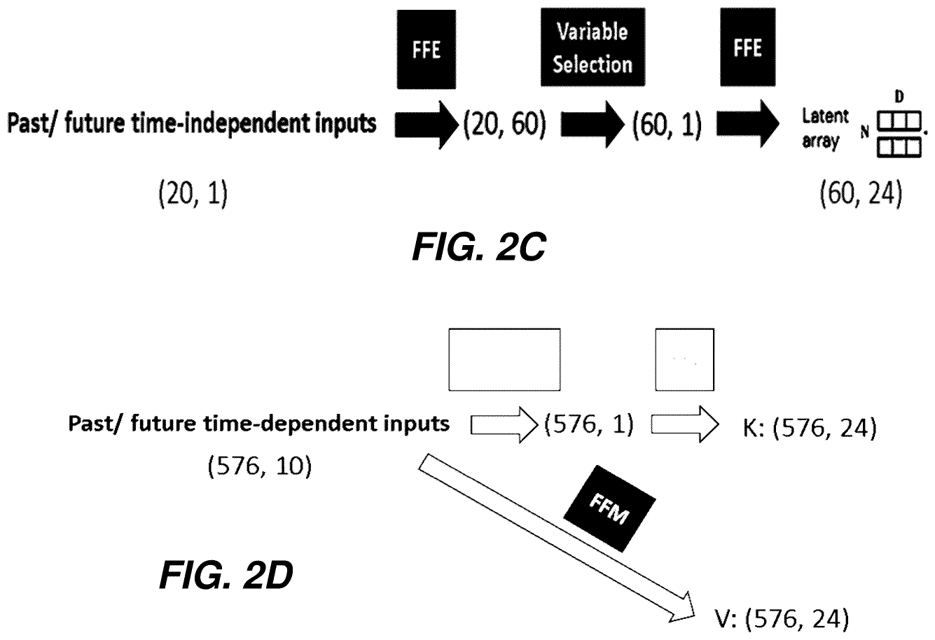

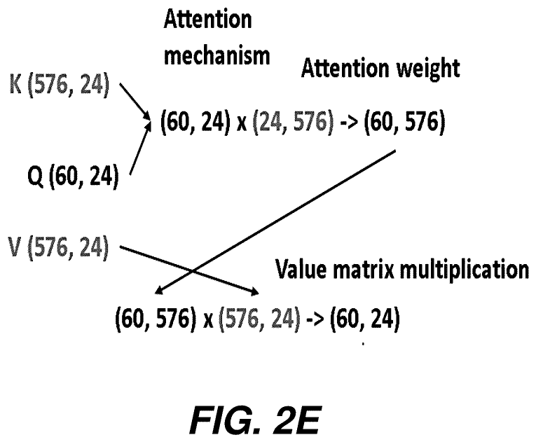

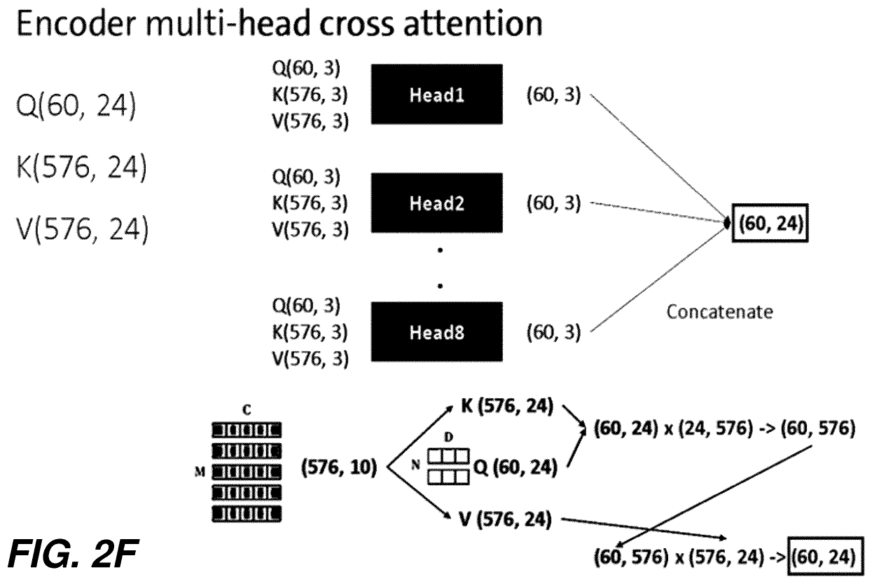

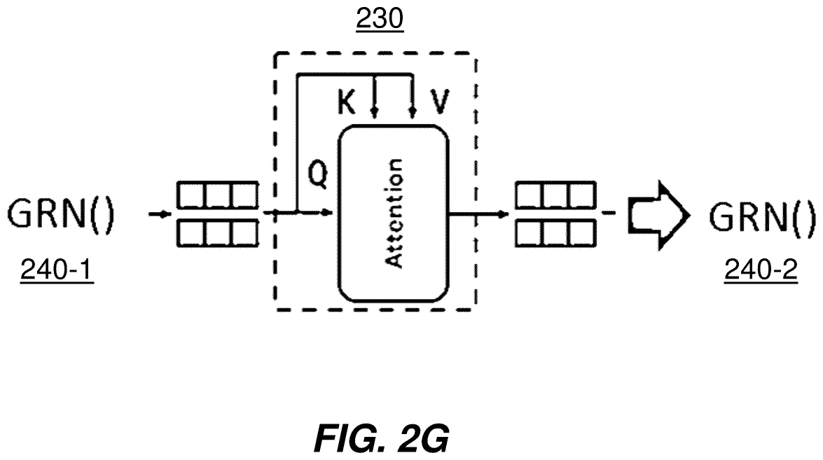

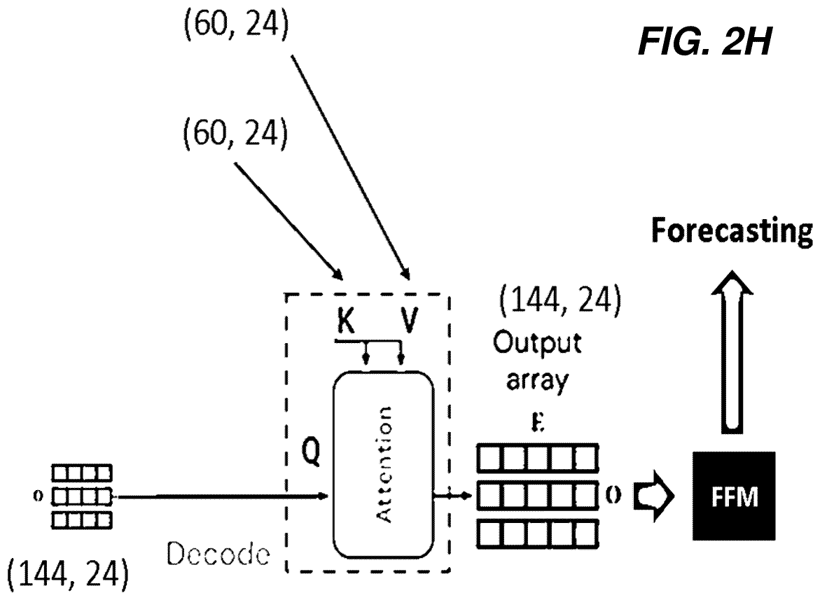

FIG. 2A illustrates an example AI/ML forecasting system or framework 200, in which techniques described herein may be practiced, according to an embodiment. The system (200) may include components such as a first encode subsystem 210-1, a second encode subsystem 210-2, a decode subsystem 220, a core model (or transform encoder) 230, etc. Additionally, optionally or alternatively, the system (200) may comprise one or more computing devices (not shown). These components including but not limited to the one or more computing devices comprise any combination of hardware and software configured to implement control and/or perform various (e.g., deep learning, transfer learning, training, pre-training, inferencing, forecasting, classification, regression, etc.) operations described herein. The one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

Past inputs, both time-dependent and time-independent, may be merged together with a first cross-attention mechanism in the first encode subsystem (210-1). In addition, future inputs can be merged together with a second cross-attention mechanism in the second encode subsystem (210-2). These (“attention”) mechanisms can be implemented to provide a capability of handling relatively (e.g., much greater than 512 elements, etc.) long input sequence by mapping relatively long time-dependent inputs into a relatively short sequence. By way of example but not limitation, an input sequence of a relatively long length of 576 inputs or elements can be mapped into a relatively short sequence or latent array of a length of 60 inputs or elements.

The past inputs or elements can be processed and passed (e.g., with relatively short sequences or latent arrays, etc.) to the core model (230) in the forecasting system (200) for the core model (230) to learn generalized patterns from the past inputs or elements (or past data).

As illustrated in FIG. 2A, the past time-independent inputs may be first pre-processed—e.g., with a variable selection mechanism (not shown in FIG. 2A), with one or more feed forward networks (not shown in FIG. 2A), etc.—into a latent array. The latent array may include N rows each of D data size such as D bytes or words. The latent array may be received or processed by the first encode subsystem (210-1) or a query (denoted as “Q”) subnetwork of the first cross-attention network implemented in the first encode subsystem (210-1).

Input sequences or signals of past time-dependent inputs or elements can have (interleaving or interstitial) missing data, which may be relatively common in real-world data. The system or an ML/AI model implemented therein can handle or process the input sequences or signals with missing data relatively robustly, using relative positional encoding encoded in, applied or adapted to the past time-dependent inputs or elements in the input sequences or signals. In some operational scenarios, relatively simple but effective positional encoding may be implemented with or adapted to a Perceiver IO architecture to handle missing time-series data in the (original) past time-dependent inputs.

As illustrated in FIG. 2A, the past time-dependent inputs may be first pre-processed—e.g., with a variable selection mechanism (not shown in FIG. 2A), with one or more feed forward networks (not shown in FIG. 2A), etc.—into inputs to be received or processed by the first encode subsystem (210-1) or a key (denoted as “K”) subnetwork and a value (denoted as “V”) subnetwork of the first cross-attention network implemented in the first encode subsystem (210-1).

Outputs generated by the first encode subsystem (210-1) or the first cross-attention mechanism or network therein-based on the inputs received by the Q, K and V subnetwork of the first cross-attention mechanism or network in the first encode subsystem (210-1)—may be fed as inputs into the core model (230). For example, the outputs of the first encode subsystem (210-1) may be duplicated into input data arrays and provided to each of the Q, K and V subnetwork of the cross-attention mechanism or network in the core model (230).

In some operational scenarios, the core model (230) may include—or may reuse through transfer learning—pre-trained transformer encoder(s) or pre-trained cross-attention mechanism(s)/network(s) for the same or different types of forecasting tasks or operations with other training or pre-training datasets other than the past or future inputs in the dataset as described herein.

As illustrated in FIG. 2A, the future (known) time-independent inputs may be first pre-processed—e.g., with a variable selection mechanism (not shown in FIG. 2A), with one or more feed forward networks (not shown in FIG. 2A), etc.—into a second latent array. The second array may include N rows each of D data size such as D bytes or words, where N and D may be the same as or different from N and D of the latent array generated with the past time-independent inputs. The second latent array may be received or processed by the second encode subsystem (210-2) or a query (denoted as “Q”) subnetwork of the second cross-attention network implemented in the second encode subsystem (210-2).

Also as illustrated in FIG. 2A, the future (known) time-dependent inputs may be first pre-processed—e.g., with a variable selection mechanism (not shown in FIG. 2A), with one or more feed forward networks (not shown in FIG. 2A), etc.—into inputs to be received or processed by the second encode subsystem (210-2) or a key (denoted as “K”) subnetwork and a value (denoted as “V”) subnetwork of the second cross-attention network implemented in the second encode subsystem (210-2).

Outputs generated by the second encode subsystem (210-2) or the second cross-attention mechanism or network therein-based on the inputs received by the Q, K and V subnetwork of the second cross-attention mechanism or network in the second encode subsystem (210-2)—may be represented as an output query array. The output query array may include O rows of the same data size. The output query array may be received or processed by the decode subsystem (220) or a query (denoted as “Q”) subnetwork of a third cross-attention network implemented in the decode subsystem (220). This output query array generated by the second cross-attention mechanism/network from the future inputs can be used as a prompt for the decode subsystem (220) to perform forecast (feature) generation.

Outputs generated by the core model or process xL subsystem (220)-based on the inputs received by the Q, K and V subnetwork of the cross-attention mechanism or network in the core model or process xL subsystem (220)—may be fed as inputs into the decode subsystem (220). For example, the outputs of the core model or process xL subsystem (220) may be duplicated into input data arrays and provided to each of the K and V subnetwork of the third cross-attention mechanism or network in the decode subsystem (220).

The decode subsystem (220) takes as input both the outputs from the core model (from the past inputs) and the prompt or output generated by the second encode subsystem (210-2) from the future inputs to generate forecasts or target forecast features represented in a (forecast feature) query array. As illustrated in FIG. 2A, the query array output or generated by the decode subsystem (220) as forecast features may include O rows of E data size.

The system (200) may be uniquely or specifically implemented to support universal time-series forecasting tasks with wide varieties of different input data types, data sampling rates, or data compositions. The system (200) can robustly handle, process or generate sequences or arrays of data elements of relatively long lengths (e.g., in input data, in output data, etc.) with the same or different sampling rates with or without missing data.

Relatively simple but effective variable selection mechanisms may be implemented in the system with a single matrix multiplication operation to help provide or enhance interpretation ability of deep learning models implemented in the system (200) or mechanisms therein.

The system (200) includes a relatively efficient time-series prompt mechanism for flexible time-series forecasting with the same or different sampling rates. The time-series prompt mechanism can be used to map a specific sampling rate in the past time-independent inputs along with future known inputs (both time-dependent and time-independent) into learnable prompts—for example, one from past inputs with the first cross-attention mechanism and another one from future inputs of the second cross-attention mechanism. The system can be implemented or adapted to handle relatively long inputs and outputs flexibly, to expedite the training phase of the system (200), and reduce inferencing times as compared with other approaches (e.g., Recurrent Neural Networks or RNNs, etc.).

Once the deep learning models in the system (200) or mechanisms therein are trained, these models can be further fine-tuned, for example by freezing some or all operational parameters such as weights and/or biases of the pre-trained models, with additional sampling rate(s) of the same or different training and/or non-training dataset(s) using transfer learning. The system (200) and models therein can be relatively efficiently generalized to support different time-series sampling rates and other variables or inputs—e.g., as a part of, in addition to, or in place of, past or future time-dependent or time-independent inputs as described herein.

### 2.4. Positional Encoding

The forecasting system (200) may be implemented with a positional encoding mechanism to encode the past and/or future time-dependent inputs with positional (or temporal) information. As the past and/or future time-dependent inputs include—or originate from—some or all (e.g., relevant, etc.) input features and (e.g., relative, input, etc.) timestamps or timing information, a relatively simple but effective positional encoding operation may be performed on the input features and timestamps to represent the past and/or future time-dependent as (corresponding) time series. The input features represented in the time series may be (e.g., valid, explicit, etc.) tokens—or data points—indexed or tagged with corresponding timestamps or timing information. As used herein, a token includes some or all (e.g., relevant, input, etc.) features at a single timestamp denoted as T.

FIG. 1D illustrates example time-dependent inputs represented as a sequence of tokens including sets of features (a1, b1), (a2, b2), (a5, b5), . . . (a23, b23), etc., with corresponding positional encoding data represented by a sequence of timestamps T1, T2, T5, . . . , T23, etc. At each of the timestamps such as T1, a token includes a respective set of features such as (a1, b1) in the sets of features. As shown the time-dependent inputs include time gaps such as between T2 and T5 for which no input data is received by the time series forecasting system or framework.

In some operational scenarios, this positional encoding mechanism encodes the timestamps or timing information of the tokens (or data points) in the time series with relative timestamps in a normalized time range such as [0, 1], [0, 10], [0, 100], etc. For example, the very first token or data point in the time series may be indexed or tagged with a first relatively time stamp of zero (0), whereas the very last token or data point in the time series may be indexed or tagged with a second relatively time stamp of one (1). All intermediate tokens or data points in the time series may be indexed or tagged with corresponding relative timestamps with the normalized range between 0 and 1. In other words, all intermediate data points may be indexed with respected to the distance from the first data point (or how far away from the first data point ranging from 0 to 1 with 1 the furthest).

Any random missing data in the past time-dependent inputs can be relatively efficiently indicated with the corresponding time series by time gaps (or intervals) for which there are no (valid or explicit) tokens indexed or tagged by timestamps or timing information within the time gaps. In other words, these time gaps (or intervals) can be simply skipped or not represented with any tokens in the time series.

In some operational scenarios, to prepare the past time-dependent inputs to be processed by ML/AI models (or mechanisms) in the forecasting system (200), all available (e.g., relevant, input, etc.) features are collected into a set or time sequence of corresponding tokens indexed or tagged with respective timestamps. Some tokens are skipped because they are missing, which is relatively common in real-world datasets.

The sequence representing the combination or aggregation of all the available tokens may be of a relatively long sequence length such as 1000+ to 10k+ to capture long term time series patterns.

In some operational scenarios, multiple sets or time sequences of tokens may be processed or learned by the ML models ML/AI models (or mechanisms) in the forecasting system (200). Zero padding operations may be performed to append filler tokens (e.g., with special values such as with zero values, with null values, empty set of input features, etc.) to some or all these multiple sets of time sequences of tokens to convert these sets or sequences into the same—or similar sized—input sequence length.

To prepare the future known time-dependent inputs, the same approach as that for the past time-dependent inputs preparation may be used. The future known time-dependent inputs or their corresponding sets or time sequences of tokens may be with or without missing data depending on specific use cases. Additionally, optionally or alternatively, relative positional encoding and zero padding operations may be implemented or performed in the same manner as those implemented or performed for the past time-dependent inputs preparation.

The past and future time-independent inputs remain the same and are not dependent on time, regardless of specific forecasting labels (or ground truths) for which these inputs are to be used in part by the forecasting system (200) to generate corresponding forecasting features. As illustrated in FIG. 1A, variable A to C (or Var A to Var C) correspond to the past known time-independent inputs, and variable D to F (or VAR D to VAR F) correspond to the future known time-independent inputs.

In connection with missing tokens in forecasting labels or ground truths (e.g., for one or more time gaps, for one or more future time points or timestamps, etc.), there are several methods or approaches to prepare forecasting labels or ground truths for which forecasting features generated by the forecasting system (200) are to be compared or measured for prediction errors (or losses).

In a first example method or approach, the overall forecasting labels or ground truths may include discontinuous forecasting labels with missing tokens, similar to how (e.g., raw, original, etc.) time-series inputs may be represented or generated for the past time-dependent inputs. The predictions errors or losses can be computed only for available tokens in the forecasting labels or ground truths, as there are missing tokens in the forecasting labels, even when but there are no missing tokens in predictions or forecasting features that are to be compared with the forecasting labels or ground truths.

In a second method or approach, the overall forecasting labels or ground truths may include all available (e.g., original, non-interpolated, etc.) forecasting labels with corresponding (e.g., non-interpolated, etc.) tokens as well as interpolated forecasting labels with interpolated tokens that cover any missing tokens time gaps within an overall forecasting time window or duration. Following the interpolation operations, the overall forecasting labels or ground truths, which may contain interpolated forecasting labels or tokens, may be continuous without time gaps within the overall forecasting time window or duration. Hence, the prediction errors or losses can be computed or measured across all labels' temporal positions or timestamps. This method or approach may be implemented or performed based at least in part on conditions or constraints on a sufficiently large number of forecasting labels or tokens to cover the overall forecasting time window or duration (e.g., over 50%, over 80%, etc.).

The second method or approach may make training or inferencing in connection with the ML/AI models or mechanisms relatively easy or consistent, as these models or mechanisms can be trained with all positions without time gaps in the forecasting time window or duration as well as used to inference for all positions without time gaps in the forecasting time window or duration.

In comparison, under the first method or approach, the ML/AI models or mechanisms may be trained for only available forecasting label (e.g., temporal, etc.) positions. Hence, resultant predictions of the ML/AI models or mechanisms may or may not be accurate for all continuous positions of the time window or duration covered by the available forecasting labels or ground truths.

The past time-dependent inputs serve as inputs to be used by the forecasting system (200) to generate the forecasting features as output. The past time-dependent inputs are represented by tokens or data points of at least at least two variables, one of which variables may be a non-timing variable and its tokens or data points may be physical sensor generated measurements or signals (e.g., voltage, current, electric charge, etc.) and the other of which variables may be corresponding timing information and its data points may be (e.g., relative, normalized, etc.) timestamps used to index or tag the tokens or data points of the non-timing variable.

At least two variables may be included in the past time-independent inputs, one of which variables is a sampling rate (or a corresponding temporal resolution) used for generating the past time-dependent inputs, and the other of which variables is an input time duration covered by the past time-dependent inputs. These two variables are used to specify for forecasting different sampling rates, different time durations, etc. Given these variables, any random missing data (or time gap) among the past time-dependent inputs can be readily inferred or deduced based on available tokens in the past time-dependent inputs.

While the timestamps can be used to indicate relative positional encoding among tokens within a relative or normalized time window or duration such as between the very first token at time point or timestamp zero (0) and the very last token at time point or timestamp one (1), the timestamps themselves may not be able to tell what an absolute total time window or duration is covered by the past time-dependent inputs (including any zero padding). Hence, the time-independent inputs are used for specifying information about the sampling rate and the total time duration of the past time-dependent inputs.

Finally, the future known time-dependent inputs may include at least one variable, data points of which represents a sequence of (future) time points or corresponding timestamps (or date) for which the forecasting features are to be generated by the forecasting system (200). The sequence of (future) time points or corresponding timestamps may be used to index or tag a sequence of tokens representing the forecasting features.

Hence, (e.g., relative, temporal, etc.) position encoding ca be applied in time-dependent inputs (past and/or future known and/or input not specific to only past). The inputs of an attention mechanism (QKV) as described herein can access or have (e.g., temporal, etc.) position information, which may be encoded with both the past and the future time-dependent inputs.

The time series forecasting system as described herein supports or provides a general and flexible forecasting framework for different combinations of past and/or future time-series inputs.

In some operational scenarios, while the past time-dependent inputs are present, some or all of the rest of past and future known inputs are optional. If the past time-independent inputs are missing, the Q subnetwork in the first encoder 210-1 may be directly mapped from a trainable latent array matrix (e.g., randomly initialized, etc.), for example in place of the missing past time-independent inputs. If the future time-dependent inputs are missing, the K and V subnetworks in the second encoder 210-2 may be directly mapped from the a (e.g., randomly initialized, etc.) trainable matrix of a pre-defined shape, for example in place of the missing future time-dependent inputs. Similarly, if the future time-independent inputs are missing, the Q subnetwork in the second encoder 210-2 may be directly mapped from the same or similar trainable matrix of the same or similar pre-defined shape.

Additionally, optionally or alternatively, if the future time-dependent inputs are present but the future time-independent inputs are missing, inputs to the K and V subnetworks in the second encoder 210-2 may be generated from outputs of variable selection mechanism(s), feed forward network(s) for element multiplication (FFE), and/or feed forward network(s) for matrix multiplication (FFM), from the available future time-dependent inputs. In comparison, inputs to the Q subnetwork in the second encoder 210-2 may not be processed generated from outputs of feed forward network(s) for element multiplication (FFE), variable selection mechanism(s), and/or feed forward network(s) for matrix multiplication (FFM) but may instead be from the trainable matrix with the pre-defined shape.

### 2.5. Encoders, Decoders and Core Model

As shown in FIG. 2A, the encode mechanism(s) or cross-attention encoder(s) in the forecasting system (200) can be implemented or used to merge different types of time-series inputs (as illustrated in FIG. 1A) together to generate different input variables or prompts to train a generalized model (e.g., the core model (230), etc.) that works relatively well for these different input variables or prompts.

For time-series forecasting, the past (time-dependent with the optional zero padding and time-independent) inputs are combined together via the first multi-head cross-attention encoder (denoted as “attention”) in the first encode subsystem (210-1). The output of the first cross-attention encoder—or the latent data array—is then passed or provided to the core model or transformer encoder (230).

The future known (time-dependent with the optional zero padding and time-independent) inputs are combined together via the second multi-head cross-attention encoder (denoted as “attention”) in the second encode subsystem (210-2). The output of the second cross-attention encoder—or the output query array—is then passed or passed to the decode subsystem (220) as prompts for the decode subsystem (220) to generate forecasting features.

The core model (230) in the forecasting system (200) may be implemented with a (e.g., pre-trained, transfer learning, etc.) transformer encoder or a transformer architecture such as a time-series transformer, Autoformer, BERT, etc. The (pre-trained or transfer learning) transformer encoder may be generalized or further trained for the different input variables or prompts generated by the multi-head cross-attention encoder(s).

In some operational scenarios, the transformer architecture in the core model may handle relatively short input sequences or input data arrays due to memory and computation limitations—e.g., BERT may be constrained to process input sequences of a maximum sequence length of 512 data elements. The multi-head cross-attention encoder(s) can be utilized to receive, convert and/or transform a relatively long input sequence (or input data array) into a relatively short latent data array as output. The relatively short latent data array or output can then be fed or received as input by the core model (230), which may be implemented with a maximum input length constraint.

The multi-head cross-attention decoder(s) or decode mechanism(s) in the forecasting system (200) can be implemented or used to map the output of the core model or transformer encoder (230) with prompts—or the output query array—derived from the future known inputs by the second cross-attention encoder into an output array resenting the (output) forecasting features. Additionally, optionally or alternatively, the output array can be further mapped to forecasting variables, features or types with one or more additional (e.g., neural network, perceptron, fully connected layers of neurons, linear, etc.) layers such as feed forward layers or other layers.

The multi-head cross-attention encoders and decoder can be separated or instantiated for each forecasting feature (type) or can be a single monolithic instance of the encoder(s) and decoder for some or all forecasting features (or feature types).

Hence, in some operational scenarios, some or all of the first encode subsystem (210-1), the second encode subsystem (210-2), and the decode subsystem (220), may be separately provided for each forecasting feature type among some or all (e.g., five, etc.) forecasting feature types. For example, a first set or combination that includes a first instance of the first encode subsystem (210-1), a first instance of the second encode subsystem (210-2), and a first instance of the decode subsystem (220), may be specifically provided for a first forecasting feature type. A second set or combination that includes a second instance of the first encode subsystem (210-1), a second instance of the second encode subsystem (210-2), and a second instance of the decode subsystem (220), may be specifically provided for a second (different) forecasting feature type.

For example, if the system (200) is used to forecast two feature types: SOC and mileage of an EV, then the system (200) may include two combinations or sets of those encode and decode mechanisms. Predicted or forecast features generated by the system (200) may be presented or visualized as variable selection plots and attention plots as shown in FIG. 1B and FIG. 1C that explain or indicate which positions of the (e.g., past, etc.) time-dependent inputs are more important to make forecasting of the SOC and mileage separately or respectively. The weights and attention scores or plots thereof can be useful for model explanation. In some operational scenarios, while some parts of the system (200) such as the encode and decode mechanisms (210 and 220) can be separated based on forecasting features or feature types, the core model (230) may remain the same for generalization purposes.

### 2.6. K, V and Q Matrices

The system (200) as illustrated in FIG. 2A may further comprise attendant mechanisms (e.g., artificial neural networks, feed forward networks, variable selection mechanisms, etc.) operating in conjunction with the cross-attention mechanisms in the encode and decode subsystems (210 and 220), respectively. These attendant mechanisms may include variable selection mechanisms that select relatively important features among all candidate or considered features for generating predicted or forecast features. The attendant mechanisms may also include feed forward networks for feed forward element-wise multiplication and feed forward networks for feed forward matrix multiplication. These attendant mechanisms or feed forward networks can be used to transform and/or map an input dimension of the (e.g., past, future known, etc.) inputs into a target or output dimension or shape.

Some or all of these variable selection mechanisms, feed forward networks for element-wise multiplication, and feed forward networks for matrix multiplication, may be used to receive and process each time-series input separately into inputs to be received and processed by Key (K), Value (V) and Query (Q) subnetworks implemented in a multi-head cross-attention encode subsystem (e.g., 210-1, 210-2, etc.) as described herein. The inputs to be received and processed by the K, V and Q subnetworks of the cross-attention encode subsystem (e.g., 210-1, 210-2, etc.) may be represented or referred to as K, V, and Q matrices, respectively.

The multi-head cross-attention encoder or subsystem (e.g., 210-1, 210-2, etc.) can then process and combine these (input) K, V and Q matrices into an output such as the latent array or output query array as shown in FIG. 2A.

By way of example but not limitation, the past time-dependent inputs can be passed as input to and processed by a combination or a sequence of a first variable selection mechanism and a first feed forward network for element-wise multiplication to generate output or K matrices to be received and processed by a first K subnetwork of the first multi-head cross-attention encode subsystem (210-1).

Similarly, the future known time-dependent inputs can be passed as input to and processed by a combination or a sequence of a second variable selection mechanism and a feed forward network for element-wise multiplication to generate output or K matrices to be received and processed by a second K subnetwork of the second multi-head cross-attention encode subsystem (210-2).

The past time-dependent inputs can also be passed as input to and processed by a first feed forward network for matrix multiplication to generate output or V matrices to be received and processed by a first V subnetwork of the first multi-head cross-attention encode subsystem (210-1).

Similarly, the future known time-dependent inputs can also be passed as input to and processed by a second feed forward network for matrix multiplication to generate output or V matrices to be received and processed by a second V subnetwork of the second multi-head cross-attention encode subsystem (210-2).

The past time-independent inputs can be passed as input to and processed by a combination or a sequence of a third feed forward network for element-wise multiplication, a third variable selection mechanism and a third feed forward network for matrix multiplication to generate output or Q matrices to be received and processed by a first Q subnetwork of the first multi-head cross-attention encode subsystem (210-1).

Similarly, the future known time-independent inputs can be passed as input to and processed by a combination or a sequence of a fourth feed forward network for element-wise multiplication, a fourth variable selection mechanism and a fourth feed forward network for matrix multiplication to generate output or Q matrices to be received and processed by a second Q subnetwork of the second multi-head cross-attention encode subsystem (210-2).

Some of the time series inputs as described herein may be optional. For example, the future known (time-independent) input may be optional. If there is no future known (time-independent) inputs, the Q matrices may be populated with random values. The output query array may be generated by the second cross-attention encode subsystem (210-2) based at least in part on trained or learned optimized operational parameters such as weights and/or biases of some or all of the fourth variable selection mechanism, the fourth feedforward network for element-wise multiplication, and the fourth feed forward network for matrix multiplication.

### 2.7. Element-Wise Multiplication

A feed forward network for element-wise multiplication as described herein may be implemented or used as a mechanism to expand the (past or future known) time-independent variables from a single row or column (in a single dimension) to any numbers of rows or columns (in multi-dimensions).

For the purpose of illustration only, in FIG. 1A, there are three past time-independent variables (Var A, Var B and Var C). A single dimension column vector of three rows may be constructed from the three time-independent variables, where each row of the three rows of the single dimension column vector consists of a respective time-independent variable—one of Var A, Var B and Var C—of the three independent variables (Var A, Var B and Var C). This single dimension column vector represents 1 (column)×3 (rows) matrix.

This single dimension column vector—or 1×3 matrix—may be expanded by a feed forward network for element-wise multiplication into any number of identical copies. These identical copies may be arranged or horizontally arrayed into a matrix of N (columns)×3 (rows), each column of which represents one of the identical copies, where N is the total number of the identical copies. Hence, the single dimension column vector—or the 1×3 matrix—may be expanded into a two-dimensional N×3 matrix, where the column dimension of the two-dimensional N×3 matrix is the same as that of the single dimension column vector and the row dimension of the N×3 matrix indicates or corresponds to the total number of identical copies, N.

For example, the single dimension column vector of the three time-independent variables (Var A, Var B and Var C) may be expanded into four identical copies each of which is represented by a respective identical copy of the single dimension column vector. These four identical copies of the single dimension column vector may be arranged or horizontally arrayed into a 4 (columns)×3 (rows) matrix, each column of which represents a respective one of the four identical copies of the single dimension column vector.

For learning purposes, the feed forward network for element-wise multiplication multiplies the resultant two-dimensional matrix (expanded from the single column vector) with element-wise multiplication operation with a learnable weights matrix—of the same dimensionality as the resultant two-dimensional matrix (e.g., a 4×3 weights matrix in the present example, etc.)—to generate an intermediate weight-multiplied matrix of the same dimensionality (4×3 in the present example). The weights matrix includes different weights (or weight elements) in different locations of the matrix. In this element-wise multiplication operation, each (variable) element at a location of the resultant two-dimensional matrix (expanded from the single column vector) is multiplied with a (weight) element at the same location of the weights matrix.

The feed forward network for element-wise multiplication can then add the intermediate weight-multiplied matrix (e.g., using a matrix addition operation, etc.) with a learnable biases matrix of the same dimensionality (4×3 in the present example) to generate a pre-normalized matrix.

In some operational scenarios, each of the rows in this pre-normalized matrix represents a pre-normalized feature vector. In the present example, there are three (3) rows and hence there are three pre-normalized feature vectors. The feed forward network for element-wise multiplication may further normalize these pre-normalized feature vectors into normalized feature vectors in a specific value range such as a 0 to 1 value range. These normalized feature vectors may be used to form an output matrix from the feed forward network for element-wise multiplication.

For the purpose of illustration only, it has been described that a single column vector may be expanded into multiple copies of the column vector to be arrayed horizontally to form a matrix that can then be multiplied with a weights matrix of the same dimensionality and added with a biases matrix of the same dimensionality, followed by normalization of feature vectors or weight-multiplied and bias added rows (or columns).

It should be noted that, in other operational scenarios, a single row vector may be similarly expanded into multiple copies of the row vector to be arrayed vertically to form a matrix that can then be multiplied with a weights matrix of the same dimensionality and added with a biases matrix of the same dimensionality, followed by normalization of feature vectors or weight-multiplied and bias added rows (or columns).

### 2.8. Variable Selection Mechanism

A variable selection mechanism as described herein may be implemented or used to identify or find which specific (e.g., input, latent, etc.) features, tokens or variables are relatively relevant and make relatively large impact on forecasting as compared with other (e.g., input, latent, etc.) features, tokens or variables.

For each time-series (past and future) inputs, each variable selection mechanism can extract or identify relatively important features for accurate forecasting. For example, the past time-dependent inputs may include or comprise ten (10) features (or feature types). Variable selection mechanism(s) can be used to identify a proper subset of features (or feature types) such as SoC and holidays among all the ten features (or feature types). Variable selection mechanism(s) can also be applied to other inputs including but not limited to the future time-dependent inputs, if available.

Additionally, optionally or alternatively, a variable selection mechanism as described herein may operate with an attention mechanism (e.g., cross attention, etc) that supports visualizing relatively important times or temporal positions or timestamps in the past or future time-dependent inputs (e.g., separately, etc.) for accurate forecasting. The peak at specific temporal positions indicates a relatively strong or heavy influence of tokens or data points on the forecast results.

A variable selection mechanism as described herein can be implemented with a relatively simple but effective matrix multiplication with a Softmax activation function. In comparison with other approaches, techniques as described herein can be relatively to implement or perform using a single matrix multiplication operation. This variable selection mechanism can be applied on each time-series input—e.g., each of the time series representing the past and future known time-dependent and time-independent inputs, etc.—separately to analyze which specific variables are more important than other variables for making (e.g., relatively accurate, etc.) forecasting.

In addition, in some operational scenarios, each time series (or inputs thereof) can be evaluated or selected with more than one variable selection mechanisms corresponding to more than one forecasting feature (or feature type).

In an example, in the past time-dependent inputs, the “mileage” variable of the vehicle may have a relatively significantly large impact on forecasting SOC of the vehicle but not so on forecasting location of the vehicle. In comparison, the “relative positional encoding” information or timing information (or timestamps) used to tag or index the past time-dependent inputs may have a larger impact on forecasting location of the vehicle than the “mileage” variable of the vehicle. Hence, in some operational scenarios, a first variable selection mechanism corresponding to the “SOC” forecasting feature (or feature type) may be used to evaluate or select relatively important variables or their corresponding tokens in the past time-dependent inputs. In these operational scenarios, a second variable selection mechanism corresponding to the “location” forecasting feature (or feature type) may be used to evaluate or select relatively important variables or their corresponding tokens in the past time-dependent inputs.

In another example, in the past time-independent inputs, the “sampling rate” variable may have a relatively significantly large impact on forecasting SOC but not so on forecasting location of the vehicle. In comparison, the past time-independent variable corresponding to “the time window or duration covered the past time-dependent” may have a larger impact on forecasting location of the vehicle than the “sampling rate” variable of the vehicle. Hence, in some operational scenarios, a third variable selection mechanism corresponding to the “SOC” forecasting feature (or feature type) may be used to evaluate or select relatively important variables or their corresponding tokens in the past time-independent inputs. In these operational scenarios, a fourth selection mechanism corresponding to the “location” forecasting feature (or feature type) may be used to evaluate or select relatively important variables or their corresponding tokens in the past time-independent inputs.

FIG. 2B illustrates an example variable selection mechanism. For the purpose of illustration only, an input or original feature vector consisting of three variables A, B and C on the left of FIG. 2B is passed to a feed forward network for element-wise multiplication to expand their single row dimension into a feature matrix of the row dimension as well as an added column dimension from 1 to any pre-specified number such as 4 (or D1 to D4) in the present example—e.g., each column of the feature matrix may be a feature vector generated with a normalized copy of the input or original feature vector multiplied with weights and added with biases. The (4×3) feature matrix on the left of FIG. 2B includes three feature vectors (each with 4 dimensions).

Subsequently, the feature vectors in the feature matrix generated by feed forward network for element-wise multiplication from the input or original feature vector are multiplied (using a relatively simple matrix multiplication operation) with a 3×4 learnable weights matrix—which may include weights Wa1, Wb1, . . . . Wa3, Wb3, Wc3, . . . . Wc4. The total number (4) of columns (D1, D2, D3 and D4) in the 3×4 weights matrix equals the total number (4) of rows of the feature matrix or equals the total number (4) of the feature vectors in the feature matrix.

Each column in the weights matrix includes respective weights (Wa, Wb, and Wc) of features in a feature vector of the feature matrix. The sum of the weights of each column equals one (1) as these weights may be set or determined with a Softmax function.

Results of the matrix multiplication between the 4×3 feature matrix and the 3×4 weights matrix are a 4×4 matrix with diagonal elements each of which is a weighted sum of a respective (or each) feature vector of features (A, B and C) in the feature matrix.

The diagonal elements of the 4×4 matrix may be collected into a single column vector or 4×1 matrix and further expanded with another feed forward network for element-wise multiplication, as illustrated on the right of FIG. 2B.

Since the weighted matrix is trainable, after finishing training the ML/AI models or mechanisms in the forecasting system (200), the weights in the weight matrix can be visualized to indicate which specific features have relatively high weights (or have relatively significant impact on forecasting) as compared with other features.

In some operational scenarios, for visualization purposes, all values in the feature (vectors) matrix may be added with a small numeric value such as 0.1 to ensure non-zero values in these features, as otherwise zero multiplied with any weights would still be zero, which might cause the weights to be negated/masked and make it difficult to interpret relative importances of the input variables or features.

### 2.9. Feedforward Matrix Multiplication

A feed forward network for matrix multiplication may be implemented or used as a mechanism to transform or convert a first shape or dimensionality of a first (input) matrix—e.g., representing the time-dependent inputs (past and future known)—into a target shape or dimensionality of a second (output) matrix. The feed forward network for matrix multiplication is useful in deep learning, as the feed forward network for matrix multiplication can be used to generate input data of a target shape or dimensionality that matches with what is expected by other mechanisms or neural networks to run the ML/AI models properly or to perform training or inferencing with the ML/AI models correctly.

For the purpose of illustration only, the time-dependent inputs may be of three variables (A, B and C) at four time steps or time points (denoted as “T1” through “T4”). The time-dependent inputs may be collected into a 4×3 matrix, each row of which represents a row vector of the three variables (A, B and C) for a respective time step or time points (one of “T1” through “T4”).

A feed forward network for matrix multiplication may be implemented or used to multiply the time-dependent inputs or the 4×3 matrix with a 3×2 learnable weights matrix with the traditional matrix multiplication operation to generate a 4×2 weight multiplied matrix, each row of which is generated by a respective row in the 4×3 matrix multiplied with each column in the 3×2 weights matrix.

This matrix multiplication effectuates a shape transformation of a first 4×3 matrix into a second 4×2 matrix, which may be of a target shape or dimensionality that matches with what is expected by downstream processing mechanisms, neural networks or ML/AI models in the forecasting network (200).

The feed forward network for matrix multiplication may further add (using a matrix addition operation) the 4×2 weight multiplied matrix to a 4×2 learnable biases matrix to generate a pre-normalized 4×2 weight multiplied bias added matrix.

The feed forward network for matrix multiplication may normalize each column (or feature vector) of the pre-normalized 4×2 matrix into a normalized 4×2 matrix.

### 3.0. Functional Overview

In an embodiment, some or all techniques and/or methods described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### 3.1. Latent Array Generation

Latent arrays (e.g., D×N latent arrays or Q matrices in FIG. 2A, etc.) can be generated by feed forward and variable selection networks/mechanisms from the (past and future) time-independent inputs, as illustrated in FIG. 2C.

For the purpose of illustration only, the (past or future) time-independent inputs may have a (e.g., data array, matrix, etc.) shape of (20, 1) which means 20 time-independent variables along a first (e.g., horizontal, etc.) dimension/direction each of which has a single variable component or element along a second (e.g., vertical, etc.) dimension/direction.

The (past or future) time-independent inputs can be passed—e.g., in this 20×1 matrix or shape, etc.—to a feed forward network for element-wise multiplication to expand the second dimensionality from 20 time-independent variables (each with a single dimension) to a pre-defined dimensionality such as (60) to generate an intermediate matrix or shape of (20, 60).

The intermediate matrix or shape of (20, 60) can be passed to a variable selection mechanism to generate a second intermediate matrix or shape of (60, 1) collected from diagonal elements of a matrix generated by the variable selection as illustrated in FIG. 2B.

The second intermediate matrix or shape of (60, 1) output from the variable selection mechanism can be further passed to a second feed forward network for element-wise multiplication to expand the dimensionality of the second intermediate matrix from (60, 1) to generate a latent array as an output matrix or shape of (60, 24).

### 3.2. K and V Input Generation

K and V inputs or matrices can be generated by feed forward and variable selection networks/mechanisms from the (past and future) time-dependent inputs, as illustrated in FIG. 2D.

For the purpose of illustration only, the (past or future) time-dependent inputs may have a (e.g., data array, matrix, etc.) shape of (576, 10) which means 576 time-dependent variables—corresponding to or indexed/tagged with respective 576 timestamps-along a first (e.g., horizontal, temporal, etc.) dimension/direction each of which has ten variable components or elements along a second (e.g., vertical, non-temporal, etc.) dimension/direction.

The (past or future) time-dependent inputs can be passed—e.g., in this 576×10 matrix or shape, etc.—to a variable selection mechanism to generate an intermediate matrix or shape of (576, 1) collected from diagonal elements of a matrix generated by the variable selection as illustrated in FIG. 2B.

The intermediate matrix or shape of (576, 1) output from the variable selection mechanism can be further passed to a feed forward network for element-wise multiplication to expand the dimensionality of the intermediate matrix from (576, 1) to generate a K matrix as an output matrix or shape of (576, 24).

The (past or future) time-dependent inputs can also be passed—e.g., in this 576×10 matrix or shape, etc.—to a feed forward network for matrix multiplication to transform the matrix or shape of (576, 10) into an output matrix or shape of (576, 24) as a V matrix.

### 3.3. Core Model Operations

A core model (e.g., 230 of FIG. 2A, etc.) as described herein may implement or include a (e.g., self, etc.) attention mechanism that performs Softmax and matrix multiplications with Q, K, and V matrices, as illustrated in FIG. 2G. In some operational scenarios, the core model (230) may operate in conjunction with one or more gating mechanisms such as an input gating mechanism 240-1 and/or an output gating mechanism 240-2 illustrated in FIG. 2G.

A gating mechanism provides or allows the flexibility to apply (e.g., optional, when needed, etc.) non-linear processing. Example non-linear processing may be, but is not necessarily limited to only, applied with any of: LayerNorm functions, Sigmoid functions, ReLU functions, ELU functions, etc.

For the purpose of illustration only, as shown in FIG. 2G, the input gating mechanism 240-1 and the output gating mechanism 240-2 are placed before and after the core model 240, respectively. The core model or the attention mechanism therein may be implemented and pre-trained (e.g., through transfer learning, etc.) as a transformer encoder.

The latent array generated by the first encoder (210-1 of FIG. 2A)—which may be a multi-head cross attention encoder—from the past (time-dependent and time-independent) inputs may be received by the input gating mechanism 240-1. The input gating mechanism 240-1 applies non-linear processing to the latent array to generate a non-linearly processed latent array to be received by the core model 230 or the transformer encoder as input.

The same non-linearly processed latent array may be used to specify, define or derive K, Q and V matrices, which are received and processed by the transformer encoder of the core model 230 or K, Q and V subnetworks therein.

The transformer encoder of the core model 230 or the (e.g., self, single-head, multi-head, etc.) attention mechanism may apply attention weights to the received Q and K matrices with a Softmax mapping/function. More specifically, the attention weights can be applied with Softmax to an intermediate matrix generated from a matrix multiplication of the Q matrix and a transpose of the K matrix.

The attention mechanism of the core model 230 can then multiply the intermediate matrix with the V matrix to generate an output array or matrix to be outputted from the attention mechanism or the transform encoder of the core model 230.

In some operational scenarios, this matrix or output array may be processed after the transform encoder by the output gating mechanism 240-2 into a non-linearly processed matrix or output array. The non-linearly processed matrix or output array may be used to define, specify or derive K and V matrices to be received by K and V subnetworks of the decoding mechanism (220 of FIG. 2A).

### 3.4. Encoder Operations

An encode mechanism or encoder (e.g., 210-1 or 210-2 of FIG. 2A, etc.) as described herein may implement or include a (e.g., cross, etc.) attention mechanism that performs Softmax and matrix multiplications with Q, K, and V matrices, as illustrated in FIG. 2E.

For the purpose of illustration only, a K matrix or shape of (576, 24), a Q matrix or shape of (60, 24), and a V matrix or shape of (576, 24), are received and processed by the encoder or subnetworks therein. These matrixes or shapes of inputs may be generated by variable selection mechanisms and feed forward networks from the (past or future) time-dependent and time-independent inputs.

The attention mechanism may apply attention weights to the received Q and K matrices with a Softmax mapping/function, which converts or normalizes a matrix multiplication of Q and K into corresponding probability distributions. These probability distributions can be useful in identifying or distinguishing which specific tokens or features—e.g., represented in the Q, K and V matrices derived from the (past and future) time-dependent inputs, etc.—are more relevant for forecasting as compared with other tokens or features among the Q, K and V matrices.

FIG. 2E illustrates example operations of a single-head attention mechanism, which may be implemented in the encoder in some operational scenarios. As shown, attention weights are applied with Softmax to an intermediate matrix or shape of (60, 576) generated from a matrix multiplication of the Q matrix of (60, 24) and a transpose of the K matrix of (576, 24).

The single-head attention mechanism can then multiply the intermediate matrix or shape of (60, 576) with the V matrix of (576, 24) to generate a matrix or shape of (60, 24) to be outputted from the single-head attention mechanism. This matrix or shape of (60, 24) may be processed by downstream ML/Ai models or mechanisms after the encoder.

FIG. 2F illustrates example operations of a multi-head attention mechanism, which may be implemented in the encoder in some operational scenarios. The multi-head attention mechanism may be used to efficiently learn relatively complex patterns among the inputs.

For the purpose of illustration, as illustrated in FIG. 2F, each of the Q, K and V matrixes is partitioned (mutually exclusives or non-overlappingly) along the second dimension into eight (8) smaller matrices of three (3) elements or components each in the second dimension.

The multi-head attention mechanism includes eight heads denoted as “Head1” through “Head8”, respectively. Like the single-head attention mechanism of FIG. 2E, each (e.g., “Head1”, etc.) of the eight heads in the multi-head attention mechanism of FIG. 2F can apply its own attention weights with Softmax to a respective intermediate matrix or shape generated from a matrix multiplication of one of the eight Q matrices of (60, 3) and a corresponding one of transposes of the eight K matrices of (576, 3).

The head (“Head1” in the present example) can then multiply the intermediate matrix or shape with a corresponding one of the eight V matrices of (576, 3) to generate a respective matrix or shape of (60, 3) to be outputted from the head (“Head1” in the present example). All eight matrices or shapes of (60, 3) outputted from the eight heads in the multi-head attention mechanism can be concatenated into an overall matrix or shape of (60, 24) as an overall output of the multi-head attention mechanism to be processed by downstream ML/Ai models or mechanisms after the encoder.

### 3.5. Decoder Operations

A decode mechanism or decoder (e.g., 220 of FIG. 2A, etc.) as described herein may implement or include a (e.g., cross, etc.) attention mechanism that performs Softmax and matrix multiplications with Q, K, and V matrices, as illustrated in FIG. 2H.

For the purpose of illustration only, a K matrix or shape of (60, 24), a Q matrix or shape of (60, 24), and a V matrix or shape of (144, 24), are received and processed by the decoder or subnetworks therein. These matrixes or shapes of inputs may be generated by an encode mechanism (e.g., 210-2 of FIG. 2A, etc.) and/or a core model (e.g., 230 of FIG. 2A or FIG. 2G, etc.) and/or a gating mechanism (e.g., 240-2 of FIG. 2G, etc.).

The attention mechanism may apply attention weights to the received Q and K matrices with a Softmax mapping/function, which converts or normalizes a matrix multiplication of Q and K into corresponding probability distributions. These probability distributions can be useful in identifying or distinguishing which specific tokens or features—e.g., represented in the Q, K and V matrices derived from the (past and future) time-dependent inputs, etc.—are more relevant for forecasting as compared with other tokens or features among the Q, K and V matrices.

FIG. 2H illustrates example operations of a single-head attention mechanism, which may be implemented in the decoder in some operational scenarios. Attention weights are applied with Softmax to an intermediate matrix or shape of (144, 60) generated from a matrix multiplication of the Q matrix of (144, 24) and a transpose of the K matrix of (60, 24).

The single-head attention mechanism can then multiply the intermediate matrix or shape of (144, 60) with the V matrix of (60, 24) to generate an output array in the form of a matrix or shape of (144, 24) to be outputted from the single-head attention mechanism. In some operational scenarios, this matrix or shape of (144, 24) or output array may be processed after the decoder by one or more of: feed forward networks for matrix multiplication, multi-layer perceptrons, etc., for the purpose of generating target predictions.

FIG. 2I illustrates example operations of a multi-head attention mechanism, which may be implemented in the decoder in some operational scenarios. The multi-head attention mechanism may be used to efficiently learn relatively complex patterns among the inputs.

For the purpose of illustration, as illustrated in FIG. 2F, each of the Q, K and V matrixes is partitioned (mutually exclusives or non-overlappingly) along the second dimension into eight (8) smaller matrices of three (3) elements or components each in the second dimension.

The multi-head attention mechanism includes eight heads denoted as “Head1” through “Head8”, respectively. Like the single-head attention mechanism of FIG. 2H, each (e.g., “Head1”, etc.) of the eight heads in the multi-head attention mechanism of FIG. 2I can apply its own attention weights with Softmax to a respective intermediate matrix or shape generated from a matrix multiplication of one of the eight Q matrices of (144, 3) and a corresponding one of transposes of the eight K matrices of (60, 3).

The head (“Head1” in the present example) can then multiply the intermediate matrix or shape with a corresponding one of the eight V matrices of (60, 3) to generate a respective matrix or shape of (144, 3) to be outputted from the head (“Head1” in the present example). All eight matrices or shapes of (144, 3) outputted from the eight heads in the multi-head attention mechanism can be concatenated into an overall matrix or shape of (144, 24) as an overall output of the multi-head attention mechanism to be processed after the decoder by one or more of: feed forward networks for matrix multiplication, multi-layer perceptrons, etc., for the purpose of generating target predictions.

### 3.6 Use Cases

The forecasting system (200) can be implemented to support a wide range of use cases or application scenarios with time-series forecasting.

For example, the forecasting system (200) may be implemented to support use cases relating to EV battery usage forecasting and generate output arrays or forecasting features representing predicted EV battery usage. Forecasting features or types may include, but are not necessarily limited to only, (general) SOC forecasting. As used herein, SOC refers to the current (available) amount of electric charge present in a battery (e.g., battery module, battery pack, etc.) represented as a percentage of a total configured usable—both used and available—capacity of the battery. SOC forecasting can help estimate how much battery capacity will be utilized during a specific journey or time period, how much an EV is to be electrically charged and when, and so on.

The forecasting system (200) may also be implemented to support use cases relating to range estimation or forecasting and generate output arrays or forecasting features representing predicted or estimated ranges. Range estimation involves forecasting a distance an EV can travel on its remaining battery charge and takes into account factors such as driving conditions, terrain, speed, and battery characteristics such as SoC to provide a relatively accurate estimate of the remaining range.

The forecasting system (200) may be implemented to support use cases relating to smart charging and generate output arrays or forecasting features representing predicted or optimized charging schedules or events. Forecasting battery usage can include predicting future charging or charger (plug in/out) availability charger and (future) driving events. These can in turn be used to automate or generate an optimized charge scheduling also known as smart charging. In addition to the smart charging, EVs may support discharging electric power to homes (V2H) or to electricity grids (V2G) in connection with various service provisions. Example service provisions relating to V2H or V2G may include, but are not necessarily limited to only, any, some or all of: overload reduction, energy imbalance service, carbon intensity service, cost savings, etc. For instance, the forecasting system (200) can assist EVs to choose charging electric power from home charging stations during a day when solar generation is high and discharging electric power to homes during peak hours when solar generation is low and electricity cost charged by the grids is high to reduce emissions and cost. When V2H or V2G technologies are activated, the forecasting system (200) can assist EV users to make energy arbitrage through smart charging and discharging behaviors. Additionally, optionally or alternatively, by having a relatively accurate prediction of future charging patterns predicted by the forecasting system (200), delayed or deferred charging (V1G) or bidirectional charging (V2H, V2G) can be executed or performed with relatively low risk as compared with scenarios in which the relatively accurate prediction of the future charging pattern is not available. Charging patterns may be different than availability (e.g., times, patterns, etc.) for charging. For example, a (e.g., standard, etc.) charging session itself may take less time than the EV availability (e.g., time window, etc.) for charging at certain charging locations or idle time at different locations. Under some approaches, the EV idle times at certain locations are not forecasted. The optimized charging solutions or scheduling may be generated or implemented by taking EV availability (for charging) input from the user. In comparison, in some operational scenarios, user confirmation may be eliminated. The system can learn and/or forecast the EV availability by location such as home availability or work availability.

The forecasting system (200) may be implemented to support use cases relating to energy management and generate output arrays or forecasting features representing predicted or estimated energy consumption. Forecasting (e.g., total, different vehicle systems implemented in an EV, etc.) energy consumption involves forecasting the total amount of energy that will be consumed by various vehicle systems of the EV including propulsion, heating, cooling, auxiliary functions, etc. Energy consumption can be proactively optimized by employing specific energy management strategies to minimize or avoid unnecessary power consumption. For instance, based on the future energy consumption of the vehicle systems of the EV, the EV can be better prepared for upcoming trips.

The forecasting system (200) may be implemented to support use cases relating to smart cooling/heating operations. Under other approaches, algorithms or heuristics may be implemented or used for cooling/heating operations that use battery power of an EV. The algorithms or heuristics may attempt to place the cabin environment inside the vehicle in a target or optimal range of ambient temperature. However, if the EV is only used for a relatively short trip or simply for moving or adjusting the EV's position in a driveway or around the house, then the cooling/heating operations that attempt to place the EV into the target range of ambient temperature inside the vehicle may not be needed or may be an overkill leading to more energy used or consumed than necessary and affecting an overall driving range performance of the EV.

By relatively accurately forecasting an upcoming trip information, future vehicle velocities, and other battery states within a specific trip, the forecasting system (200) can help optimize cooling/heating operations based on these forecasts and proactively prepare the vehicle while saving overall energy costs. Instead of using a fixed or set strategy of trying to always place the vehicle in a target range of ambient environment or to perform cooling/heating to reach the target range whenever the vehicle is turned on, the optimization algorithm can receive forecasting results with uncertainty from the forecasting system (200) and take into consideration the uncertainty into optimization strategies based on the uncertainty and forecasts of future vehicle events or trips or movements, thereby generating relatively powerful or robust optimization strategies that deal with relatively rare events or uncertainties, leading to relatively low operational costs and long driving ranges for the EV or its user and hence to an improved EV user experience.

The forecast system (200) may be implemented to operate with other (e.g., digital twin, etc.) systems or learning models. For example, future battery usage can be forecast and fed into the other systems/models. These other systems/models may predict or track how EV battery performance characteristics will change over time. The prediction or tracking of the EV battery performance over time can provide relatively deep insights leading to proactive maintenance as well as relatively accurate estimation or prediction of remaining useful battery life.

For the purpose of illustration only, it has been described that the forecasting system (200) as described herein can be applied to many use cases relating to electric vehicles. It should be noted, however, that in other operational scenarios, the forecasting system (200) may be implemented to support many other use cases or other time series forecasting that may or may not be related to electric vehicles. For instance, the forecasting system (200) may be implemented to other use cases relating to industrial, financial, energy, and agricultural sectors.

### 3.7. Optimizing EV Charging

For the purpose of illustration only, some or all of these techniques can be implemented or used to optimize EV charging operations as part of an overall smart home energy management system or framework. The increasing adoption of EVs brings challenges and opportunities for smart residential energy management optimization. A use case for a machine learning system (or forecasting framework) such as 200 of FIG. 2A is EV charging control in the overall smart home energy management system or framework. The forecasting framework may operate in conjunction with optimization algorithms based on heuristics, linear programing (LP) or reinforcement learning (RL), etc. These optimization algorithms can be implemented or performed to minimize costs and emissions for each individual charging session, which leads to long-term saving in costs and emissions in connection with electrical energy consumption and emissions cost when EV charging occurs at home.

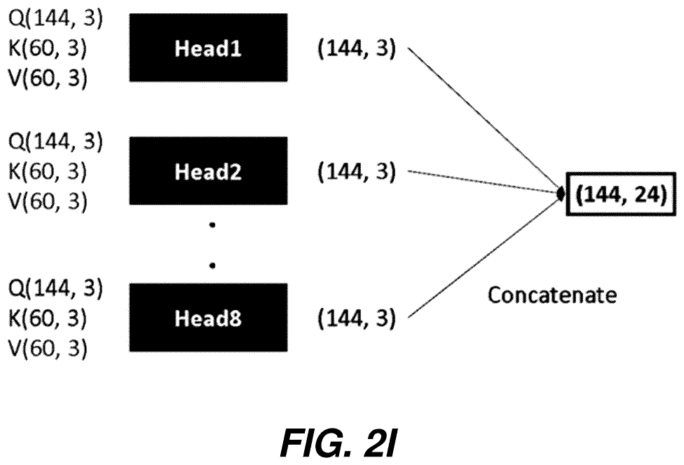

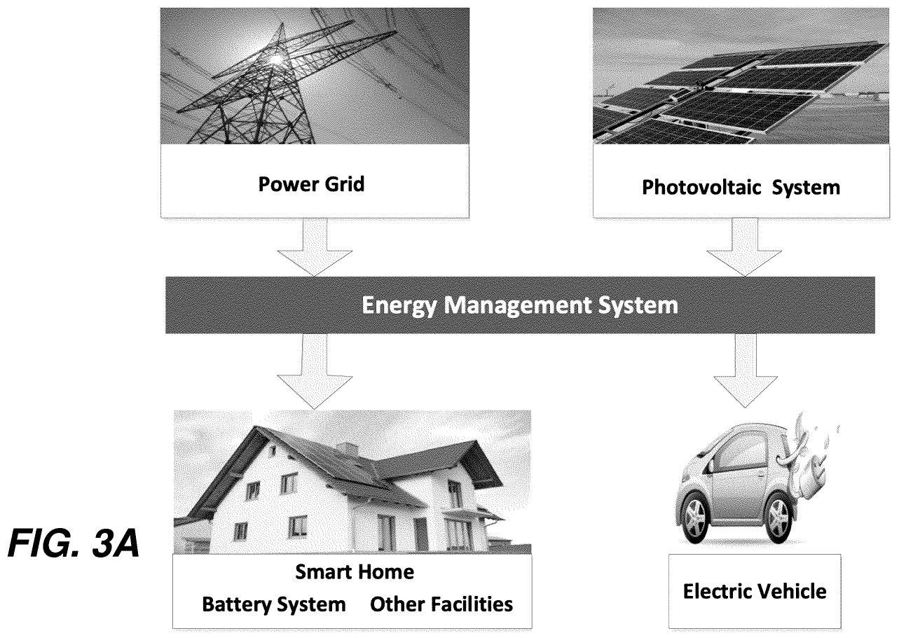

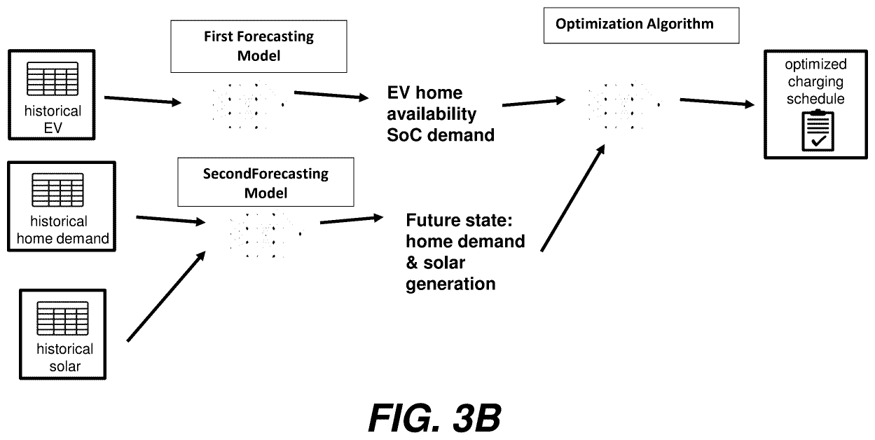

FIG. 3A illustrates an example smart home energy management system or framework operating in conjunction with a power grid (or a electricity supply network of a utility company) to which a home is connected, a renewable energy generation system such as a photovoltaic (or wind) power generation system deployed with the home, a home based battery storage or system or other residence or home-based energy storage facilities, electric vehicle(s) associated with—or operated by resident(s) of—the home, etc. Some or all of these other systems such as the power grid, the energy generation system, the battery storage or system, the electric vehicle(s) can be operatively linked (e.g., permanently, temporarily, plugged in, etc.), or in communication, with the home energy management system.

Home based renewable energy generation including solar and/or wind power generation are becoming an important power source for more and more homes. However, the output of solar power can be quite intermittent and varies depending on different weather conditions. Additionally, optionally or alternatively, residence or home based energy storage is also becoming an important component for many smart homes.

In some operational scenarios, the home with which the home energy management system operates is equipped or installed with solar panels enabling solar power generation and a home-based battery system. The battery system at the home can be used to save or temporarily store energy or power surplus for later use, thereby helping mitigate or work around the volatility or variability of renewable energy generation. The battery system or batteries therein can be charged and discharged with continuous power rates ranging from zero to (e.g., configured, rated, etc.) maximum allowed charging/discharging rate(s). One or more (e.g., advanced, etc.) EV chargers may also be installed in the home to enable bi-directional charging.

The power consumption of the smart home may be (e.g., mainly, 90%, 95% or more, etc.) divided into two groups: EV charging power consumption and (non-EV) home base load power consumption. The home base load power consumption includes all other power consumptions in the home except the EV charging, namely power consumptions for home appliances, cooling, heating, fans, interior lights, etc. For the home base load power consumptions, there may exist a morning peak after inhabitants wake up and an evening peak when they arrive back home, assuming they are regularly leaving the home during the weekdays to go to work.

FIG. 3B illustrates an example smart home energy management system or framework that may implement or include forecasting models or optimization algorithms to optimize EV charging and manage power demands including base load power consumptions and EV charging power consumptions.

The smart home energy management system may include one or more time series forecasting systems (e.g., 200 of FIG. 2A, etc.) to implement the forecasting models or algorithms.

For the purpose of illustration only, the forecasting models may include a first forecasting model that forecasts, predicts or estimate the (e.g., next, upcoming, etc.) EV availability window demarcated by forecasts, predictions or estimations of an EV arrival time (denoted as t_arrival) and an EV departure time (denoted as t_departure). Additionally, optionally or alternatively, the first forecasting model may be implemented or used to forecast, predict or estimate a State-of-Charge (SoC) demand needed at the EV departure time. A SoC demand or SoC needed at the EV departure time may refer to a demand or charged capacity of an EV that meets or satisfies driving (e.g., vehicle propulsion, vehicle non-propulsion, etc.) demands or needs of the EV after the EV leaves the home within the next 24 hours.

The forecasts, predictions or estimations of the EV availability window (t_arrival, t_departure) and the SoC demand needed at the EV departure time can be made by the first forecasting model that has learned or trained from available EV historical usage data. The predicted EV availability window and the SoC demand at the EV departure time as generated by the first forecasting model may be received as first input (e.g., input states, input features, etc.) by (e.g., reinforcement learning or RL based, linear programming or LP based, etc.) optimization algorithm(s) to generate optimized charging schedule(s).

As illustrated in FIG. 3B, the forecasting models may include a second forecasting model that forecasts, predicts or estimate the (e.g., next, upcoming, etc.) future states relating to (non-EV) home demand and solar generation for a future time window such as the next 24 hours.

More specifically, the forecasts, predictions or estimations of these future states can be made by the second forecasting model that has learned or trained from available historical home power demand/consumption data and available historical solar generation data. The second forecasting model may be implemented, trained or used to model the (e.g., short-term, next 24 hours, etc.) electricity home load forecasting and solar generation forecasting from the historical home power demand/consumption data and solar generation data.

The predicted future home power demand and the solar generation as generated by the second forecasting model may be received as second input (e.g., input states, input features, etc.) by the (e.g., reinforcement learning or RL based, linear programming or LP based, etc.) optimization algorithm(s) to generate the optimized charging schedule(s).

Based at least in part on current predictions or observations such as the predicted EV arrival time, the predicted EV departure time, the predicted SoC demand at the predicted EV departure time, the predicted non-EV home demand, the predicted solar generation, etc., the optimization algorithm(s) can make control decisions for EV charging operations or optimize the charging schedule(s) for the EV(s). As the forecasting models can be trained to predict future states relatively accurately, better control policies or optimized EV charging schedule(s) may be generated by the smart home energy management system or the optimization algorithm(s) therein.

### 3.8. Forcasting SOC and Home Availability

In a training phase, one or more forecasting models implemented with a time series forecasting system or framework may be trained, tested and/or validated with a training dataset. The training dataset may be collected from a population (e.g., thousands, tens of thousands, etc.) of electric vehicles (e.g., including but not limited to hybrid vehicles, etc.).

Input data included in the training dataset can be used to generate input features representing past and/or future known time-dependent and time-independent inputs. Example input features may, but are not necessarily limited to, be of: a (e.g., historical, past, etc.) SoC type indicating exact SoC values for each time step/point of a past time duration before a forecasting time period or duration; a Change of Mileage type indicating a mileage change (e.g., mileage_current minus mileage_previous, etc.) of electric vehicle(s) per timestamp (e.g., every one or more time steps/points, etc.) in a plurality of timestamps in a past time duration; a Home type indicating whether an electric vehicle is at home or not (e.g., 0 or 1, etc.) for a given timestamp in a plurality of timestamps in a past time duration; a Day (of week) type indicating whether a given day or a timestamp or time point/step therein is on a specific day of week (e.g., Monday to Sunday, etc.); a Holiday type indicating whether a given day or a timestamp or time point/step therein is on a holiday; a Season type indicating which specific season a given day or a timestamp or time point/step therein is in; a States type indicating which state or a state group (e.g., clustered based on latitudes and longitudes of states, etc.) the home is located; a Relative Timestamp type indicating relative timestamps (relative to a beginning time point) of time steps/points; a wall clock type indicating wall clock times to which timestamps or time steps/points correspond; an Input Time Duration type indicating a specific time period, window or duration a set of data or a time series covers; etc.

The input data in the training dataset may include future known inputs such as a wall clock times, day of week, season, holiday, etc., for any timestamp or time step/point or any time duration in a forecasting time period or duration.

The input data in the training dataset includes ground truths or input data portion used to generate the ground truths corresponding to one or more forecasting labels. Forecasting results may be compared with the ground truths through loss (or error/objective) function to determine prediction errors. In the training phase, the prediction errors may be back propagated to adjust or optimize operational parameters such as weights and/or biases used in the prediction models.

As used herein, a forecasting label may refer to a type of forecasting results generated by a time series forecasting system or framework. For the purpose of illustration only, the forecasting labels may include a SoC type corresponding to forecasted or predicted SoC (states) of electric vehicle(s) over a forecasting period or duration such as one day or two days (or a shorter or longer time duration). Additionally, optionally or alternatively, the forecasting labels may include a Home type corresponding to forecasted or predicted home availability—available for electrically charging electric vehicle(s) at home—of electric vehicle(s) over a forecasting period or duration such as one day or two days (or a shorter or longer time duration).

For example, the training dataset may include time varying battery usage data of these electric vehicles such as (e.g., physical, sensor generated, realtime, near realtime, etc.) battery usage measurements and related measurements collected from the population of electric vehicles.

A portion of the time varying battery usage data in the training data may represent battery usage and/or related data in connection with an individual electric vehicle in the population of electric vehicle for a specific time duration such as one day, two days, one or more weeks, etc.

In some operational scenarios, the time varying battery usage data in the training dataset may be acquired or collected with a relatively high temporal resolution such as every few seconds or less, every few minutes or less, etc. Data preprocessing operations may be performed on the training dataset to sample the training dataset including but not necessarily limited to the time varying battery usage data therein based on one or more specific (data) sampling rates to generate time series at the one or more specific sampling rates.

In a first example, some or all of the input data in the training dataset may be sampled at a first sampling rate such as every ten (10) minutes to generate a plurality of time series each of which may be a time series (or a time sequence) of tokens for a plurality of time points covering a specific time duration (e.g., one day, two days, etc.) at the specific sampling rate of every ten (10) minutes.

In a second example, some or all of the input data in the training data set may be sampled at a second sampling rate such as every twenty (20) minutes to generate a plurality of time series each of which may be a time series (or a time sequence) of tokens for a plurality of time points covering a specific time duration (e.g., one day, two days, etc.) at the specific sampling rate of every twenty (20) minutes.

In some operational scenarios, a raw time series—in or derived from the input data of the training dataset—that has an aggregated or individual time gap greater than a maximum time gap threshold (e.g., 7 days, 1008 tokens for 10-minute sampling rate, etc.) may be excluded from being selected to generate input features to train the forecasting models as described herein.

The time series sampled from the input data in the training set may be used as raw time-series inputs representing past time-dependent inputs, (forecasting) future known time-dependent inputs, and ground truths or labels.

A sliding (time) window mechanism may be applied to the input data in the training dataset or the input data therein to generate different raw time series covering or corresponding to different time windows. For example, the overall input data in the training dataset may cover relatively large time durations (e.g., one or more days, one or more weeks, one or more months, one or more seasons, one or more years, etc.). A sliding window may be used to shift or slide a relatively small time window (e.g., one hour, one day, two days, etc.) through or over some or all of these relatively large time durations. Different (e.g., mutually exclusive, non-overlapping, non-intersecting, overlapping, intersecting, moving or sliding, etc.) time windows may be used to generate different (e.g., candidate, selected, final, etc.) raw time series as described herein.

An entire length of a time series (e.g., raw, past time-dependent input, future known time-dependent input, etc.) included in a training data instance may comprise a specific total number (e.g., a fixed number, 500, 600, 800, etc.) of tokens. These tokens may include any (e.g., filler, default, empty set, etc.) tokens within a time gap inside a total time duration covered by the time series. Given the total time duration, the total number of tokens in the time series may depend on the specific sampling rate used to sample the input (or original) data in the training dataset to generate the time series.

A forecasting period or duration—for generating forecasting results or predictions to be compared with ground truths or labels—may be a specific time duration such as one (1) day and/or two (2) days. A total number (e.g., 144, 288, etc.) of tokens to be generated or predicted or forecasted in the forecasting period or duration (e.g., one day, two days, etc.) and compared with corresponding ground truths or labels for computing prediction errors depend on a particular sampling rate specifically selected for forecasting operations.

The ground truths or labels may be represented by sequences of sets of tokens available for the forecasting period or duration. The total number of the available tokens that represent the ground truths or labels may be less than the total number of tokens that would (e.g., contiguously, continuously, without time gap, etc.) cover the entire forecasting period or duration.

In some operational scenarios, the total number of the available tokens that represent the ground truths or labels may be constrained to be no less than a first percentile threshold such as 10% of the total number of tokens that would (e.g., contiguously, without time gap, etc.) cover the entire forecasting period or duration. Additionally, optionally or alternatively, all the available tokens that represent the ground truths or labels may be constrained to cover (e.g., with or without time gaps, etc.) at least a second percentile threshold such as 50% of the entire forecasting period or duration.

Under these constraints, the available tokens can be interpolated or extended to generate additional interpolated tokens to cover all the missing tokens in the time gaps of the forecasting period or duration. The available tokens and the interpolated tokens may be combined to represent new ground truths or labels in place of the ground truths or labels represented by the available tokens alone. The new ground truths or labels represented by the available tokens and the interpolated tokens may be used for training purposes to compute prediction errors based on an applicable loss (or error/objective) function.

In some operational scenarios, the ground truths or labels as represented by the available tokens but not interpolated tokens may be used for training purposes. Hence, in these operational scenarios, predictions or estimations associated with missing tokens or time gaps may be omitted from prediction error computations. The prediction errors are only computed for time points—in the forecasting period or duration—covered by the available tokens.

Input and/or output features of the forecasting models may be identified from the raw time series (inputs), future known inputs, ground truths, labels, timestamps, etc., in the training dataset. For the purpose of illustration only, a plurality of input features (or types) such as ten (10) features (or types) including relative timestamps and (e.g., input, output or forecasting, etc.) time duration, etc., may be identified in the training dataset. Vectors or vector components—or matrices or matrix components—representing these input features (or types) may be normalized into a specific value range such as between zero (0) and one (1). The normalized input features may be received by the forecasting models to generate forecasting results such as two output features for SoC and Home (availability) predictions in the forecasting period or duration.

The input and/or output features identified from the training dataset may be partitioned into three parts. The first part (e.g., 70%, etc.) of the training dataset is for training or optimizing operational parameters such as weights and/or biases of the forecasting models for different sampling rates. The forecasting results using input features in this part of the training dataset can be compared with the output features identified in the training dataset representing the ground truths or labels to generate prediction errors based on the loss (or error/objection) function. The prediction errors can be back-propagated to adjust or optimize the operational parameters to minimize future prediction errors.

The second part (e.g., 15, etc.) of the training dataset may be for testing purposes. The third second part (e.g., 15, etc.) of the training dataset may be for validation purposes. These parts of the training dataset can be used to assess effectiveness, efficiency, confidence level, correctness or performance of the forecasting models in generating the forecasting results or predicted output features (to be compared with the output features in the ground truths/labels) for different sampling rates. True negative, true positive, false positive, false negative, etc., may be assessed or measured for classification types (e.g., home availability, etc.) of the forecasting results. Quantile losses or numeric prediction errors/values may be assessed or measured relative to the ground truths for regression types (e.g., SoC, etc.) of the forecasting results. Confusion matrices and/or uncertainty in the forecasting results may be estimated or generated and provided as a part of input to a recipient system such as optimizing models for generating optimized charging schedules.

A (e.g., weighted, etc.) loss function as described herein used in connection with the training dataset may be a (e.g., weighted, etc.) combination of quantile losses at quantiles 10, 50, and 90 (for SOC regression loss with uncertainty) and/or cross entropy losses (for home availability classification with a value of 0 or 1). The weighted loss function can be implemented depending on one or more factors. In an example, the weighted loss function may be implemented with weighted losses by features (e.g., focus on or giving relatively large weights to forecasting home availability as compared with forecasting SOC. In another example, the weighted loss function may be implemented with weighted loss by distribution—where the frequency of some data such as a SoC value of 75 (7) is relatively low compared to other SoC values, the weighted loss of the corresponded data (e.g., the SoC value of 75, etc.) may be assigned a relatively high weight than other SoC values. In yet another example, the weighted loss function may be implemented with assigning a relatively large weighted loss to transition points (such as data in connection with points of transitions where the state of home availability changes from 0 (or not home) to 1 (or home) or change from 1 (or home) to 0 (or not home). This may be used to overcome or reduce data biases in favor of data points (or tokens) representing more common occurrences such as non-transition points at the expenses of the transition points or relatively rare occurrences. In a further example, the weighted loss function may be implemented with assigning relatively large weights to SoC not at home—as compared with SoC at home—to help focus on forecasting SOC not at home more accurately than the SOC at home.

In the model training phase, the forecasting models may be first trained with one or more specific sampling rates (e.g., every 10 minute sampling rate, every 20 minute sampling rate, etc.) for different forecasting periods/durations (e.g., 12 hours, one day, two days, etc.). Some or all of the operational parameters—such as weights or biases used in the transformer encoder or core model (e.g., multiple attention heads with GELU( ) activation function, etc.) in the time series forecasting system or framework—optimized or adjusted in the training may be frozen after the model training phase with the one or more specific sampling rates, while some other of the operational parameters—such as weights or biases used in encoders or decoder in the time series forecasting system or framework—may be further trained or fine-tuned for different sampling rates in subsequent model training and/or application phases. The forecasting models may be validated or tested with one or more training dataset portions.

In the model application/inference phase, the forecasting models may be deployed with a home with electric vehicle(s). Input data representing past and future known (dependent and/or independent) inputs (e.g., of same types as in the training dataset, etc.) may be in part or in whole generated or collected by home-based systems and/or EV(s) or physical sensors therein. Some of the input data may be raw time series. The same input features (or input feature types) may be generated from the input or raw time series data inputs and used by the trained forecasting models to generate or make predictions of SoC states/values or home availability states/values in connection with the EV(s) for one or more specific sampling rates over one or more specific forecasting periods/durations.

### 3.9. Forcasting Home Energy Demand/Generation

In a training phase, one or more forecasting models implemented with a time series forecasting system or framework may be trained, tested and/or validated with a training dataset to predict home energy demand and/or generation. The training dataset may be collected from a population (e.g., thousands, tens of thousands, etc.) of homes with electric vehicles (e.g., including but not limited to hybrid vehicles, etc.).

Input data included in the training dataset can be used to generate input features representing past and/or future known time-dependent and time-independent inputs relating to home energy demand/generation. For example, the training dataset may include time varying home energy demand and/or generation data of these homes such as (e.g., physical, sensor generated, realtime, near realtime, etc.) energy demand/generation measurements and related measurements collected from the population of homes.

The input data in the training dataset may include future known inputs such as a wall clock times, day of week, season, holiday, etc., for any timestamp or time step/point or any time duration in a forecasting time period or duration.

The input data in the training dataset includes ground truths or input data portion used to generate the ground truths corresponding to one or more forecasting labels. Forecasting results may be compared with the ground truths through loss (or error/objective) function to determine prediction errors. In the training phase, the prediction errors may be back propagated to adjust or optimize operational parameters such as weights and/or biases used in the prediction models.

Input and/or output features of the forecasting models may be identified from the raw time series (inputs), future known inputs, ground truths, labels, timestamps, etc., in the training dataset. For the purpose of illustration only, a plurality of input features (or types) such as ten (10) features (or types) including relative timestamps and (e.g., input, output or forecasting, etc.) time duration, etc., may be identified in the training dataset. Vectors or vector components—or matrices or matrix components—representing these input features (or types) may be normalized into a specific value range such as between zero (0) and one (1). The normalized input features may be received by the forecasting models to generate forecasting results such as two output features for home energy demand/generation predictions in the forecasting period or duration.

A (e.g., weighted, etc.) loss function as described herein used in connection with the training dataset may be a (e.g., weighted, etc.) combination of quantile losses at quantiles 10, 50, and 90 of home energy demand/generation (features).

In the model training phase, the forecasting models may be first trained with one or more specific sampling rates (e.g., every 10 minute sampling rate, every 20 minute sampling rate, etc.) for different forecasting periods/durations (e.g., 12 hours, one day, two days, etc.).

In the model application/inference phase, the forecasting models may be deployed with a home with electric vehicle(s). Input data representing past and future known (dependent and/or independent) inputs (e.g., of same types as in the training dataset, etc.) may be in part or in whole generated or collected by home-based systems or physical sensors therein. Some of the input data may be raw time series. The same input features (or input feature types) may be generated from the input or raw time series data inputs and used by the trained forecasting models to generate or make predictions of energy demand/generation with the home for one or more specific sampling rates over one or more specific forecasting periods/durations.

### 4.0. Example Process Flows

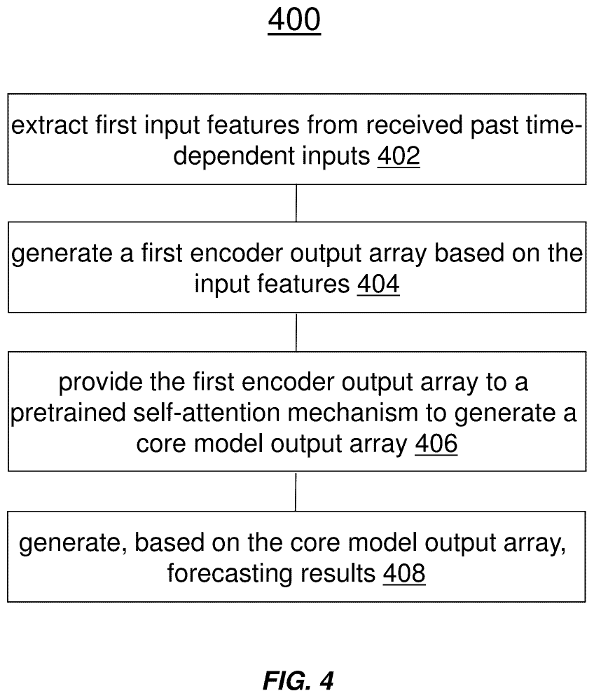

FIG. 4 illustrates an example process flow 400 according to an embodiment. In some embodiments, one or more computing devices or components may perform this process flow. In block 402, a system (e.g., a time series forecasting system, etc.) as described herein extracts first input features from received past time-dependent inputs. The first input features are represented at least in part by a first plurality of input time series.

In block 404, the system generates, by a first encoder with a first cross-attention mechanism based at least in part on the first input features, a first encoder output array.

In block 406, the system provides the first encoder output array as query, key and value inputs to a pretrained core model with a self-attention mechanism to generate a core model output array.

In block 408, the system generates, by a decoder based at least in part on the core model output array, forecasting results in a forecasting time period. The forecasting results are represented by one or more output time series.

In an embodiment, the system further performs: extracting second input features from received future time-dependent inputs, the second input features being represented at least in part by a second plurality of input time series; generating, by a second encoder with a second cross-attention mechanism based at least in part on the second input features, a prompt to the decoder; the forecasting results are generated by the decoder based further on the prompt generated by the second encoder.

In an embodiment, the system further performs: generating, by a pre-processing mechanism from received time-independent inputs, a latent array of a predefined shape, the pre-processing mechanism including a sequence of a first feed forward network for element multiplication, a variable selection mechanism, and a second feed forward network for element multiplication; providing the latent array of the predefined shape as a query input to one of: a second encoder designated to process future inputs or the first encoder designated to process past inputs.

In an embodiment, the past time-dependent inputs are preprocessed into a key input to the first encoder by a variable selection mechanism and followed by a feed forward network for element multiplication; the past time-dependent inputs are preprocessed into a value input to the first encoder by a feed forward network for matrix multiplication.

In an embodiment, at least one of the first encoder or the pretrained core model includes multiple attention heads.

In an embodiment, the first input features are encoded with relative temporal positional information.

In an embodiment, the first plurality of input time series includes a specific input time series comprising physical sensory data in a specific contiguous time duration; the specific contiguous time duration includes one or more time gaps for which there is no physical sensor data available in the specific time series.

In an embodiment, the forecasting results include predictions of one or more of: future State of Charge (SoC) values of an electric vehicle (EV), future home availabilities of the EV, future electricity demands of a home for the EV, or future electricity generation of the home; the forecasting results are used by an optimization system to generate future electricity charging scheduling events for the EV.

In an embodiment, a computing device is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Other examples of these and other embodiments are found throughout this disclosure. Note that, although separate embodiments are discussed herein, any combination of embodiments and/or partial embodiments discussed herein may be combined to form further embodiments.

### 5.0. Implementation Mechanism—Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

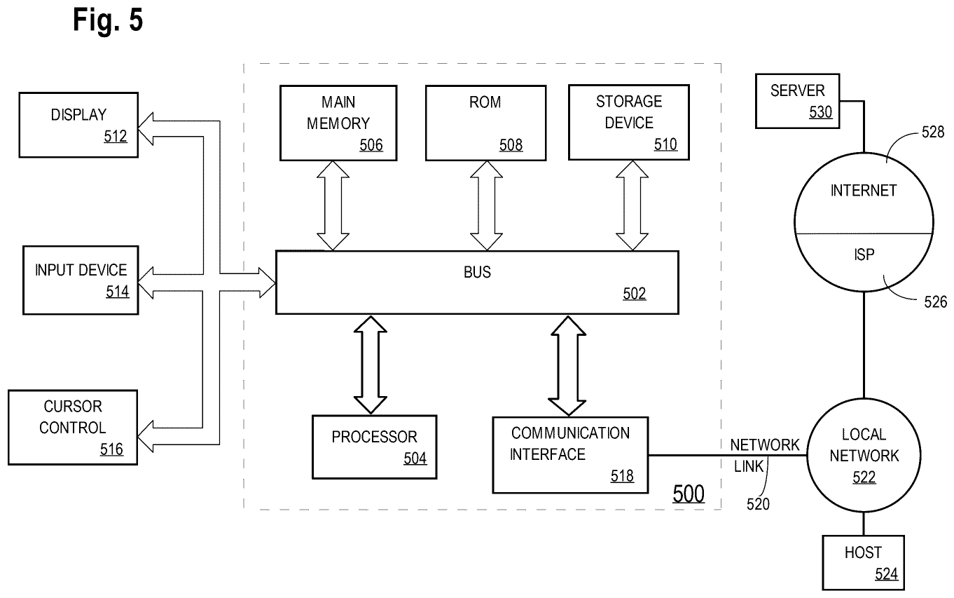

FIG. 5 is a block diagram that illustrates a computer system 500 utilized in implementing the above-described techniques, according to an embodiment. Computer system 500 may be, for example, a desktop computing device, laptop computing device, tablet, smartphone, server appliance, computing main image, multimedia device, handheld device, networking apparatus, or any other suitable device.

Computer system 500 includes one or more busses 502 or other communication mechanism for communicating information, and one or more hardware processors 504 coupled with busses 502 for processing information. Hardware processors 504 may be, for example, a general purpose microprocessor. Busses 502 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 500 also includes a main memory 506, such as a random access memory (RAM) or other dynamic or volatile storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes one or more read only memories (ROM) 508 or other static storage devices coupled to bus 502 for storing static information and instructions for processor 504. One or more storage devices 510, such as a solid-state drive (SSD), magnetic disk, optical disk, or other suitable non-volatile storage device, is provided and coupled to bus 502 for storing information and instructions.

Computer system 500 may be coupled via bus 502 to one or more displays 512 for presenting information to a computer user. For instance, computer system 500 may be connected via a High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 512 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 512.

In an embodiment, output to display 512 may be accelerated by one or more graphics processing unit (GPUs) in computer system 500. A GPU may be, for example, a highly parallelized, multi-core floating point processing unit highly optimized to perform computing operations related to the display of graphics data, 3D data, and/or multimedia. In addition to computing image and/or video data directly for output to display 512, a GPU may also be used to render imagery or other video data off-screen, and read that data back into a program for off-screen image processing with very high performance. Various other computing tasks may be off-loaded from the processor 504 to the GPU.

One or more input devices 514 are coupled to bus 502 for communicating information and command selections to processor 504. One example of an input device 514 is a keyboard, including alphanumeric and other keys. Another type of user input device 514 is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. Yet other examples of suitable input devices 514 include a touch-screen panel affixed to a display 512, cameras, microphones, accelerometers, motion detectors, and/or other sensors. In an embodiment, a network-based input device 514 may be utilized. In such an embodiment, user input and/or other information or commands may be relayed via routers and/or switches on a Local Area Network (LAN) or other suitable shared network, or via a peer-to-peer network, from the input device 514 to a network link 520 on the computer system 500.

A computer system 500 may implement or include techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 500 can receive the data on the network and demodulate the signal to decode the transmitted instructions. Appropriate circuitry can then place the data on bus 502. Bus 502 carries the data to main memory 505, from which processor 504 retrieves and executes the instructions. The instructions received by main memory 506 may optionally be stored on storage device 510 either before or after execution by processor 504.

A computer system 500 may also include, in an embodiment, one or more communication interfaces 518 coupled to bus 502. A communication interface 518 provides a data communication coupling, typically two-way, to a network link 520 that is connected to a local network 522. For example, a communication interface 518 may be an integrated services digital network (ISDN) card, cable modem, satellite modem, or a modem to provide a data communication connection to a corresponding type of telephone line. As another example, the one or more communication interfaces 518 may include a local area network (LAN) card to provide a data communication connection to a compatible LAN. As yet another example, the one or more communication interfaces 518 may include a wireless network interface controller, such as an 802.11-based controller, Bluetooth controller, Long Term Evolution (LTE) modem, and/or other types of wireless interfaces. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by a Service Provider 526. Service Provider 526, which may for example be an Internet Service Provider (ISP), in turn provides data communication services through a wide area network, such as the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

In an embodiment, computer system 500 can send messages and receive data, including program code and/or other types of instructions, through the network(s), network link 520, and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. As another example, information received via a network link 520 may be interpreted and/or processed by a software component of the computer system 500, such as a web browser, application, or server, which in turn issues instructions based thereon to a processor 504, possibly via an operating system and/or other intermediate layers of software components.

In an embodiment, some or all of the systems described herein may be or comprise server computer systems, including one or more computer systems 500 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 6.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising:
extracting first input features from received past time-dependent inputs, wherein the first input features are represented at least in part by a first plurality of input time series;
generating, by a first encoder with a first cross-attention mechanism based at least in part on the first input features, a first encoder output array;
providing the first encoder output array as query, key and value inputs to a pretrained core model with a self-attention mechanism to generate a core model output array;
generating, by a decoder based at least in part on the core model output array, forecasting results in a forecasting time period, wherein the forecasting results are represented by one or more output time series.

2. The method of claim 1, further comprising:
extracting second input features from received future time-dependent inputs, wherein the second input features are represented at least in part by a second plurality of input time series;
generating, by a second encoder with a second cross-attention mechanism based at least in part on the second input features, a prompt to the decoder;
wherein the forecasting results are generated by the decoder based further on the prompt generated by the second encoder.

3. The method of claim 1, further comprising:
generating, by a pre-processing mechanism from received time-independent inputs, a latent array of a predefined shape, wherein the pre-processing mechanism includes a sequence of a first feed forward network for element multiplication, a variable selection mechanism, and a second feed forward network for element multiplication;
providing the latent array of the predefined shape as a query input to one of: a second encoder designated to process future inputs or the first encoder designated to process past inputs.

4. The method of claim 1, wherein the past time-dependent inputs are preprocessed into a key input to the first encoder by a variable selection mechanism and followed by a feed forward network for element multiplication; wherein the past time-dependent inputs are preprocessed into a value input to the first encoder by a feed forward network for matrix multiplication.

5. The method of claim 1, wherein at least one of the first encoder or the pretrained core model includes multiple attention heads.

6. The method of claim 1, wherein the first input features are encoded with relative temporal positional information.

7. The method of claim 1, wherein the first plurality of input time series includes a specific input time series comprising physical sensory data in a specific contiguous time duration; wherein the specific contiguous time duration includes one or more time gaps for which there is no physical sensor data available in the specific time series.

8. The method of claim 1, wherein the forecasting results include predictions of one or more of: future State of Charge (SoC) values of an electric vehicle (EV), future home availabilities of the EV, future electricity demands of a home for the EV, or future electricity generation of the home; wherein the forecasting results are used by an optimization system to generate future electricity charging scheduling events for the EV.

9. One or more non-transitory computer readable media storing a program of instructions that is executable by one or more computing processors to perform:
extracting first input features from received past time-dependent inputs, wherein the first input features are represented at least in part by a first plurality of input time series;
generating, by a first encoder with a first cross-attention mechanism based at least in part on the first input features, a first encoder output array;
providing the first encoder output array as query, key and value inputs to a pretrained core model with a self-attention mechanism to generate a core model output array;
generating, by a decoder based at least in part on the core model output array, forecasting results in a forecasting time period, wherein the forecasting results are represented by one or more output time series.

10. The media of claim 9, wherein the program of instructions is executable by the one or more computing processors to perform:
extracting second input features from received future time-dependent inputs, wherein the second input features are represented at least in part by a second plurality of input time series;
generating, by a second encoder with a second cross-attention mechanism based at least in part on the second input features, a prompt to the decoder;
wherein the forecasting results are generated by the decoder based further on the prompt generated by the second encoder.

11. The media of claim 9, wherein the program of instructions is executable by the one or more computing processors to perform:
generating, by a pre-processing mechanism from received time-independent inputs, a latent array of a predefined shape, wherein the pre-processing mechanism includes a sequence of a first feed forward network for element multiplication, a variable selection mechanism, and a second feed forward network for element multiplication;
providing the latent array of the predefined shape as a query input to one of: a second encoder designated to process future inputs or the first encoder designated to process past inputs.

12. The media of claim 9, wherein the past time-dependent inputs are preprocessed into a key input to the first encoder by a variable selection mechanism and followed by a feed forward network for element multiplication; wherein the past time-dependent inputs are preprocessed into a value input to the first encoder by a feed forward network for matrix multiplication.

13. The media of claim 9, wherein at least one of the first encoder or the pretrained core model includes multiple attention heads.

14. The media of claim 9, wherein the first input features are encoded with relative temporal positional information.

15. The media of claim 9, wherein the first plurality of input time series includes a specific input time series comprising physical sensory data in a specific contiguous time duration; wherein the specific contiguous time duration includes one or more time gaps for which there is no physical sensor data available in the specific time series.

16. The media of claim 9, wherein the forecasting results include predictions of one or more of: future State of Charge (SoC) values of an electric vehicle (EV), future home availabilities of the EV, future electricity demands of a home for the EV, or future electricity generation of the home; wherein the forecasting results are used by an optimization system to generate future electricity charging scheduling events for the EV.

17. A system comprising: one or more computing processors; one or more non-transitory computer readable media storing a program of instructions that is executable by the one or more computing processors to perform:
extracting first input features from received past time-dependent inputs, wherein the first input features are represented at least in part by a first plurality of input time series;
generating, by a first encoder with a first cross-attention mechanism based at least in part on the first input features, a first encoder output array;
providing the first encoder output array as query, key and value inputs to a pretrained core model with a self-attention mechanism to generate a core model output array;
generating, by a decoder based at least in part on the core model output array, forecasting results in a forecasting time period, wherein the forecasting results are represented by one or more output time series.

18. The system of claim 17, wherein the program of instructions is executable by the one or more computing processors to perform:
extracting second input features from received future time-dependent inputs, wherein the second input features are represented at least in part by a second plurality of input time series;
generating, by a second encoder with a second cross-attention mechanism based at least in part on the second input features, a prompt to the decoder;
wherein the forecasting results are generated by the decoder based further on the prompt generated by the second encoder.

19. The system of claim 17, wherein the program of instructions is executable by the one or more computing processors to perform:
generating, by a pre-processing mechanism from received time-independent inputs, a latent array of a predefined shape, wherein the pre-processing mechanism includes a sequence of a first feed forward network for element multiplication, a variable selection mechanism, and a second feed forward network for element multiplication;
providing the latent array of the predefined shape as a query input to one of: a second encoder designated to process future inputs or the first encoder designated to process past inputs.

20. The system of claim 17, wherein the past time-dependent inputs are preprocessed into a key input to the first encoder by a variable selection mechanism and followed by a feed forward network for element multiplication; wherein the past time-dependent inputs are preprocessed into a value input to the first encoder by a feed forward network for matrix multiplication.

21. The system of claim 17, wherein at least one of the first encoder or the pretrained core model includes multiple attention heads.

22. The system of claim 17, wherein the first input features are encoded with relative temporal positional information.

23. The system of claim 17, wherein the first plurality of input time series includes a specific input time series comprising physical sensory data in a specific contiguous time duration; wherein the specific contiguous time duration includes one or more time gaps for which there is no physical sensor data available in the specific time series.

24. The system of claim 17, wherein the forecasting results include predictions of one or more of: future State of Charge (SoC) values of an electric vehicle (EV), future home availabilities of the EV, future electricity demands of a home for the EV, or future electricity generation of the home; wherein the forecasting results are used by an optimization system to generate future electricity charging scheduling events for the EV.
